(19) United States
(12) Patent Application Publication
(10) Pub. No.: US 2024/0072234 A1
(43) Pub. Date: Feb. 29, 2024

(54) BATTERY ELECTRODE AND MANUFACTURE THEREOF

(71) Applicant: Rivian IP Holdings, LLC, Plymouth, MI (US)

(72) Inventors: Ashwin Krishna Murali, Dublin, CA (US); Meng Wang, Pleasanton, CA (US); Ki Tae Park, Santa Clara, CA (US)

(21) Appl. No.: 17/897,382

(22) Filed: Aug. 29, 2022

(51) Int. Cl. H01M 4/04

(52) U.S. Cl. CPC H01M 4/0435

(57) ABSTRACT

Manufacture of battery electrodes with decoupled pressure points is provided. For example, a system to manufacture a battery electrode can include a first roller and a second roller that define a first tangent line. The first roller and the second roller can apply force to a battery active material received between the first roller and the second roller to form a film. The second roller and a third roller can define a second tangent line that intersects the first tangent line. The second roller and the third roller can apply force to the film received between the second roller and the third roller.

### INTRODUCTION

Electric vehicles can use electricity to drive a motor. The electricity can be provided by a battery that can hold an electrical charge. However, it can be challenging to efficiently produce components for batteries at a large scale in a reliable manner.

### SUMMARY

This technology is directed to the manufacture of battery electrodes with decoupled pressure points. For example, a system of this technical solution can include multiple of decoupled pressure points formed by at least one roller. Each pressure point can define a tangent line that extends tangent to a surface of the roller at (e.g., proximate, near to, close to, adjacent) the pressure point. The system can include a first pressure point that can receive and apply force to a battery active material (e.g., electrode active material) to form a film. The system can include a second pressure point to apply force to the film to achieve a desired film thickness. The system can include a third pressure point to laminate the film to a current collector material. The system can include a first tangent line of the first pressure point that intersects a second tangent line of the second pressure point. The system can isolate forces applied at the first pressure point from forces applied at the second pressure point by including intersecting first and second tangent lines to decouple the first pressure point from the second pressure point.

At least one aspect of this technology can be directed to a system to manufacture a battery electrode that can include a first roller and a second roller that define a first tangent line. The first roller and the second roller can apply force to a battery active material received between the first roller and the second roller to form a film. The second roller and a third roller can define a second tangent line that intersects the first tangent line. The second roller and the third roller can apply force to the film received between the second roller and the third roller.

At least one aspect of this technology can be directed to a method. The method can include applying, via a first roller and a second roller, a first force to a first battery active material. The first roller and the second roller can define a first tangent line. The method can include applying, via the second roller and a third roller, force to the first battery active material. The second roller and the third roller can define a second tangent line that intersects the first tangent line. The method can include laminating, via the third roller and a fourth roller, the first battery active material with a current collector material. The third roller and the fourth roller can define a third tangent line.

At least one aspect of this technology can be directed to a battery electrode that includes a first battery active material laminated with a current collector material. The battery electrode can be produced by applying, via a first roller and a second roller, a first force to first battery active material. The first roller and the second roller can define a first tangent line. The battery electrode can be produced by applying, via the second roller and a third roller, force to the first battery active material. The second roller and the third roller can define a second tangent line that intersects the first tangent line. The battery electrode can be produced by laminating, via the third roller and a fourth roller, the first battery active material with a current collector material. The third roller and the fourth roller can define a third tangent line.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example system for manufacturing a battery electrode, in accordance with some aspects.

FIG. 2 depicts an example system for manufacturing battery electrode, in accordance with some aspects.

FIG. 3 depicts an example system for manufacturing a battery electrode, in accordance with some aspects.

FIG. 4 depicts an example system for manufacturing a battery electrode, in accordance with some aspects.

FIG. 5 depicts an example system for manufacturing a battery electrode, in accordance with some aspects.

FIG. 6A depicts an example system for manufacturing a battery electrode, in accordance with some aspects.

FIG. 6B depicts an example system for manufacturing a battery electrode, in accordance with some aspects.

FIG. 7 depicts an example system for manufacturing a battery electrode, in accordance with some aspects.

FIG. 8 is a flow diagram of an example method of manufacturing a battery electrode, in accordance with some aspects.

FIG. 9 is a flow diagram of an example method of manufacturing a battery electrode, in accordance with some aspects.

FIG. 10 depicts an example vehicle, in accordance with some aspects.

FIG. 11 depicts an example battery pack, in accordance with some aspects.

FIG. 12 depicts an example battery module, in accordance with some aspects.

FIG. 13 depicts a cross-sectional view of an example battery cell, in accordance with some aspects.

FIG. 14 is a block diagram illustrating an example architecture for a computer system that can be employed to implement elements of the systems and methods described herein, including, for example, the systems depicted in FIGS. 1 and 3-7 and the methods depicted in FIGS. 8-9.

### DETAILED DESCRIPTION

Following below are more detailed descriptions of various concepts related to, and implementations of, methods, apparatuses, and systems of battery electrode manufacturing. The various concepts introduced above and discussed in greater detail below may be implemented in any of numerous ways.

This disclosure is directed to manufacture of battery electrodes with decoupled pressure points. The system can include a plurality of pressure points formed by at least one roller. Each pressure point can define a tangent line that extends tangent to a surface of the roller at (e.g., proximate to, near, close to, adjacent) the pressure point. For example, a first pressure point can receive and shear a battery active material (e.g., an electrode active material) into a film (e.g., an electrode film). A second pressure point can compress the film to achieve a desired density or thickness. A third pressure point can laminate the compressed film to a current collector foil. The second pressure point can be adjacent to or can share a roller with the first pressure point. The third pressure point can be adjacent to or can share a roller with the second pressure point. For example, the system can include a fourth pressure point that can receive and shear a second battery active material (e.g., an electrode active material) into a second film (e.g., an electrode film). The system can include a fifth pressure point that can compress the second film to achieve a desired density or thickness. The third pressure point can laminate the compressed second film to a second side of the current collector foil. The fifth pressure point can be adjacent to or share a roller with the fourth pressure point. The fifth pressure point can be adjacent to or share a roller with the third pressure point. The system can be used to produce a battery electrode for use in an electric vehicle or otherwise.

The various pressure points (e.g., the first pressure point, the second pressure point, the third pressure point, the fourth pressure point, and the fifth pressure point) can be decoupled. For example, one pressure point can be considered decoupled from an adjacent pressure point if the two pressure points have tangent lines that intersect (e.g., are not parallel with) each other. For example, the first pressure point can have a substantially vertical tangent line, while the second pressure point can have a substantially horizontal tangent line. In an example, the third pressure point can have a substantially vertical tangent line, while the second pressure point can have a substantially horizontal tangent line. The various pressure points need not have tangent lines that are substantially vertical or horizontal; each of the pressure points can have tangent lines of various angular orientations that intersect.

This technology can improve the process of manufacturing electrodes for batteries. For example, the integrated calendar-laminator with decoupled pressure points can allow for use of rollers having varying diameters, which can provide better control of shearing or compression operations relative to rollers with the same diameters, while also allowing for systems or rollers of smaller sizes. The system can also allow for improved performance with rollers of a similar diameter or size. The system can improve quality control by isolating forces applied at each pressure point from other pressure points; a movement of a roller associated with one pressure point does not impart a reaction force on a roller of an adjacent pressure point. By isolating forces, the system can prevent or substantially reduce process variation (e.g., variation in film thickness or density) that may occur if pressure points are not decoupled. For example, forces exerted at each pressure point can avoid affecting other rollers or pressure points.

Electrodes for batteries can be manufactured using a dry powder, a semi-dry material, an arid mix, or some other active material. As rollers compress the powder via pressure points to create a film, the film can push or move the rollers relative to central axes of the rollers. For example, multiple rollers can be placed along a same plane in series and the pressure points of the multiple roller pairs are coupled with one another, and the film can move or push multiple rollers from a respective central axis point, which can compound how much a roller is offset from its central axis, thereby introducing defects into the electrode material and reducing a satisfactory yield for the electrode material. Furthermore, having rollers placed along a same plane can increase the footprint of a manufacturing facility. In addition, having rollers coupled with one another along a same plane can increase the difficulty of controlling or modifying the compression or shearing operation at one pressure point without also having to control or modify rollers associated with other pressure points. Thus, this technical solution can improve the electrode manufacturing process while reducing the footprint of a manufacturing facility or multi-calendar laminator assembly and improving the controllability of pressure points. For example, by having decoupled pressure or pinch points between rollers, an offset of the roller from its central axis caused by the film traveling through a pressure point may not be compounded, thereby reducing the amount of tuning or calibration that is performed on the manufacturing assembly. Further, since rollers can be placed vertically and horizontally, a greater number of rollers can be housed in a given footprint relative to all the rollers being on a same plane, thereby allowing for a smaller manufacturing facility or area. In addition, a decoupled pressure point can be controlled independently without affecting other pressure points.

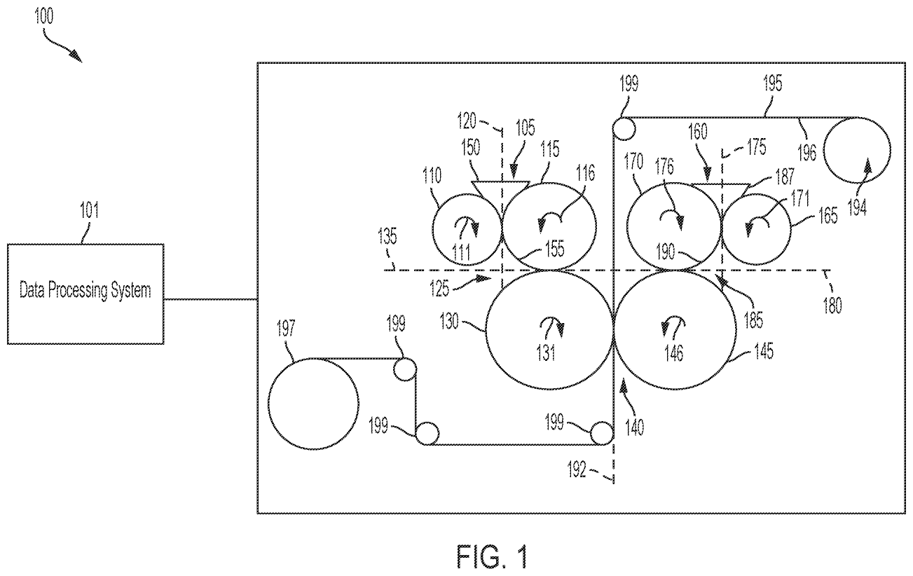

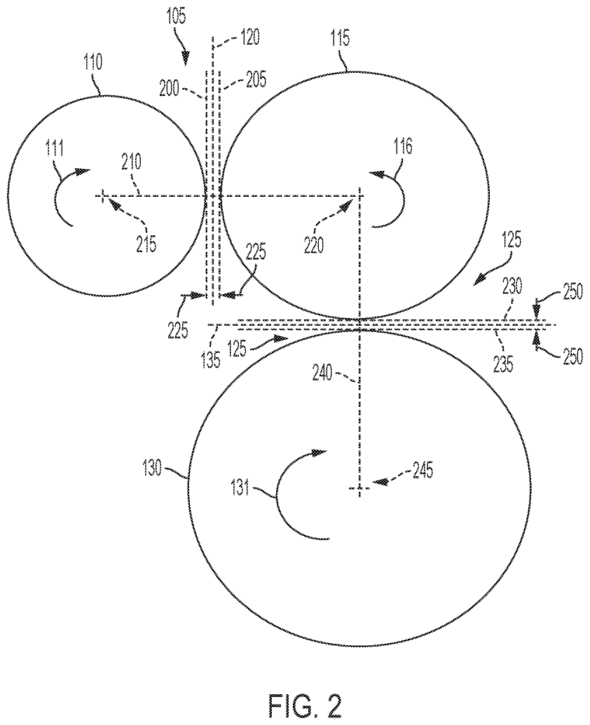

FIGS. 1 and 2, among others, depict an example system 100 to manufacture an electrode. The system can produce an electrode for a battery. For example, the system 100 can produce an electrode for a rechargeable battery of an electric vehicle, such as an electric truck or electric sport utility vehicle (SUV). Among other examples, the system 100 can produce electrodes for a lithium ion (Li-ion) battery. The system 100 can produce a cathode electrode or an anode electrode that, when used in a battery, can receive electrical current or release electrons. For example, the system 100 can receive a dry powdered material as an input and can produce an electrode including at least one battery active layer joined with (e.g., laminated with) a current collector material. The system 100 can produce an electrode including a first film joined with a first side of a current collector material and a second film joined with a second side of the current collector material.

The system 100 can include a first roller 110 and second roller 115 that define a first tangent line 120. The first roller 110 and the second roller 115 can define a first pressure point 105 between the first roller 110 and the second roller 115. For example, the first pressure point 105 can be a gap (e.g., a space, a nip, an opening) between the first roller 110 and the second roller 115 where an outer surface of the first roller 110 and an outer surface of the second roller 115 are closest (e.g., where a distance between an outer surface of the first roller 110 and an outer surface of the second roller 115 is smallest).

As depicted in FIG. 2, the first roller 110 can define a line 200 that extends tangent to the outer surface of the first roller 110 at the first pressure point 105. The second roller 115 can define a line 205 that extends tangent to the outer surface of the second roller 115 at the first pressure point 105. A centerline 210 can extend from a first centerpoint 215 of the first roller 110 to a centerpoint 220 of the second roller 115. The line 200 and the line 205 can be perpendicular to the centerline 210 at the first pressure point 105. The line 200 and the line 205 can be oriented at some other angle (e.g., 30 degrees offset, 15 degrees offset) relative to the centerline 210 at the first pressure point 105. In an example, the first tangent line 120 can be parallel with the line 200 and the line 205. The first tangent line 120 can be perpendicular to the centerline 210. The first tangent line 120 can extend between the first roller 110 and the second roller 115 through the first pressure point 105. The first tangent line 120 can be substantially vertical (e.g., ±30 degrees from vertical), for example. The first tangent line 120 can have some other orientation, such as ±45 degrees from vertical, ±30 degrees from horizontal, substantially horizontal, or otherwise. The first roller 110 can be separated from the second roller 115 at a first distance 225, where the first distance 225 can be a distance between the line 200 and the line 205 at the first pressure point 105 (e.g., at the centerline 210).

The first roller 110 can have a first roller diameter. The second roller 115 can have a second roller diameter. For example, the first roller diameter is less than the second roller diameter. The first roller diameter can be the same as or substantially similar to (e.g., ±15%) the second roller diameter. The second roller 115 diameter can have a diameter that is 1.5 times the first roller diameter, greater than 1.5 times the first roller diameter, or in some other proportion relative to the first roller diameter, for example. The first roller 110 can rotate about a first axis in a first direction 111. The second roller 115 can rotate about a second axis in a second direction 116. The first axis can be parallel with the second axis. The first direction 111 can be opposite the second direction 116. The first roller 110 can rotate about the first axis at a first circumferential speed to achieve a first angular velocity. The second roller 115 can rotate about the second axis at a second circumferential speed to achieve a second angular velocity. The first circumferential speed can be the same as or substantially similar to (e.g., ±15%) the second circumferential speed. The first circumferential speed can be different than the second circumferential speed. For example, the second circumferential speed can be 1.5 to two times faster than the first circumferential speed. The first angular velocity can be different than the second angular velocity. For example, the second angular velocity can be 1.5 to two times greater than the first angular velocity. The first angular velocity can be the same as or substantially similar to (e.g., ±15%) the second angular velocity, for example.

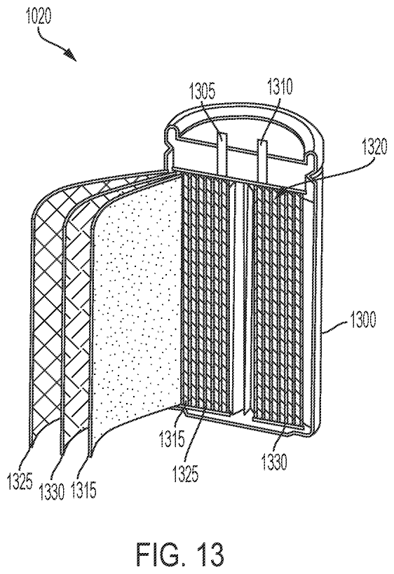

The system 100 can include the first roller 110 and the second roller 115 to apply force (e.g., a shearing force or a compressive force) to a first battery active material 155 (e.g., electrode active material) received between the first roller 110 and the second roller 115 to form a film (e.g., an electrode film). For example, the first roller 110 and the second roller 115 can rotate inwards towards the first pressure point 105 to pull or draw the first battery active material 155 into and through the first pressure point 105 between the first roller 110 and the second roller 115. As the battery active material 155 is drawn through the first pressure point 105, a force is applied to compress or shear the battery active material 155 to form a film. For example, the first roller 110 can rotate in the first direction 111 at the first speed and first angular velocity, while the second roller 115 contra-rotates in the second direction 116 at the second speed and second angular velocity, where the first speed or first angular velocity is less than the second speed or angular velocity, respectively. A difference in circumferential speed or angular velocity of the first roller 110 and the second roller 115 can create a shearing force that shears the battery active material 155 as it passes through the first pressure point 105. For example, a film comprising the battery active material 155 is created as the battery active material 155 is sheared through the first pressure point 105. The film can include a thickness that is proximate to the first distance 225 (e.g., the distance between the first roller 110 and the second roller 115 at the first pressure point 105). A compressive force can be applied at the first pressure point 105 to affect the thickness of the film. The gap between the first roller 110 and the second roller 115 (e.g., the first distance 225) at the first pressure point 105 can define a thickness of the film. The gap between the first roller 110 and the second roller 115 can be adjusted to modify the thickness of the film, for example. The compressive force can be applied by virtue of the first battery active material 155 passing through the first pressure point 105 between the first roller 110 and the second roller 115. An actuator or other device can act on the first roller 110 or the second roller 115 to create a compressive force as the first battery active material 155 passes through the first pressure point 105 between the first roller 110 and the second roller 115. The thickness of the film can also be affected (e.g., reduced) by a speed differential between the first roller 110 and the second roller 115. For example, the second circumferential speed can be greater than the first circumferential speed. The first battery active material 155 can be material suitable to produce an anode electrode layer (e.g., anode 1315 of FIG. 13 and discussed below) or a cathode electrode layer (e.g., cathode 1325 of FIG. 13 and discussed below).

The system 100 can include a third roller 130. The second roller 115 and the third roller 130 can define a second tangent line 135. The second roller 115 and the third roller 130 can define a second pressure point 125 between the second roller 115 and the third roller 130. For example, the second pressure point 125 can be a gap (e.g., a space, a nip, an opening) between the second roller 115 and the third roller 130 where an outer surface of the second roller 115 and an outer surface of the third roller 130 are closest (e.g., where a distance between an outer surface of the second roller 115 and an outer surface of the third roller 130 is smallest).

As depicted in FIG. 2, among others the second roller 115 can define a line 230 that extends tangent to the outer surface of the second roller 115 at the second pressure point 125. The third roller 130 can define a line 235 that extends tangent to the outer surface of the third roller 130 at the second pressure point 125. A centerline 240 can extend from the centerpoint 220 of the second roller 115 to a centerpoint 245 of the third roller 130. The line 230 and the line 235 can be perpendicular to the centerline 240 at the second pressure point 125. For example, the second tangent line 135 can be parallel with the line 230 and the line 235. The second tangent line 135 can be perpendicular to the centerline 240. The second tangent line 135 can extend between the second roller 115 and the third roller 130 through the second pressure point 125. The second tangent line 135 can be substantially vertical. The second tangent line 135 is substantially horizontal or some other orientation. The second roller 115 can be separated from the third roller 130 at a second distance 250, where the second distance 250 can be a distance between the line 230 and the line 235 at the second pressure point 125 (e.g., at the centerline 240).

The third roller 130 can include a third roller diameter. For example, the third roller diameter can be greater than the second roller diameter or the first roller diameter. The third roller diameter can be 1.5 times bigger than the second roller diameter, for example. The third roller diameter can be the same as or substantially similar to (e.g., ±15%) the first roller diameter or the second roller diameter. The third roller 130 can rotate about a third axis in a third direction 131. The third axis can be parallel with both the first axis and the second axis. The third direction 131 can be opposite the second direction 116. The third direction 131 can be the same as the first direction 111. The third roller 130 can rotate about the third axis at a third circumferential speed to achieve a third angular velocity. For example, the third circumferential speed can be different than the first circumferential speed or the second circumferential speed. The third circumferential speed can be 1.5 to four times greater than the second circumferential speed or the first circumferential speed. The third circumferential speed can be the same as or substantially similar to (e.g., ±15%) the first circumferential speed or the second circumferential speed. The third angular velocity can be different than the first angular velocity or the second angular velocity. For example, the third angular velocity can be 1.5 to four times greater than the second angular velocity or the third angular velocity. The third angular velocity can be the same as or substantially similar to (e.g., ±15%) the first angular velocity or the second angular velocity.

The system 100 can include the second roller 115 and the third roller 130 to apply force (e.g., a shearing force or a compressive force) to a film received between the second roller 115 and the third roller 130. For example, the second roller 115 and the third roller 130 can receive the battery active material 155 that has been sheared into a film by the first roller 110 and the second roller 115 at the first pressure point 105. The second roller 115 and the third roller 130 can receive the battery active material 155 at the second pressure point 125. For example, the second roller 115 and the third roller 130 can rotate inwards towards the second pressure point 125 to pull or draw the battery active material 155, which can be sheared into a film at the first pressure point 105, into and through the second pressure point 125 between the second roller 115 and the third roller 130. As the battery active material 155 is drawn through the second pressure point 125, it is compressed or sheared to form a second film. The second roller 115 can rotate in the second direction 116 at the second speed and second angular velocity, while the third roller 130 contra-rotates in the third direction 131 at the third speed and third angular velocity. For example, the second speed or second angular velocity can be less than the third speed or third angular velocity, respectively. A difference in circumferential speed or angular velocity of the second roller 115 and the third roller 130 can create a shearing force that shears or compresses the battery active material 155 as it passes through the second pressure point 125. For example, a second film comprising the battery active material 155 is created as the film comprising the battery active material 155 created at the first pressure point 105 is sheared through the second pressure point 125. The second film can include a thickness that is proximate to the second distance (e.g., the distance between the second roller 115 and the third roller 130 at the second pressure point 125). A compressive force can be applied at the second pressure point 125 to affect the thickness of the second film. For example, the second distance 250 is less than the first distance 225. The second film created by the second roller 115 and the third roller 130 at the second pressure point 125 can be thinner than the film created by the first roller 110 and the second roller 115 at the first pressure point 105. The gap between the second roller 115 and the third roller 130 at the second pressure point 125 can define a thickness of the second film. The gap between the second roller 115 and the third roller 130 can be adjusted to modify the thickness of the second film, for example. A differential between the third circumferential speed of the third roller 130 and the second circumferential speed of the second roller 115 can affect (e.g., reduce) a thickness of the second film.

The first roller 110, the second roller 115, and the third roller 130 can experience reaction forces as the battery active material 155 passes through the first pressure point 105 or the second pressure point 125, respectively. For example, the battery active material 155 can impart a reaction force on the first roller 110 and the second roller 115 at the first pressure point 105 that can cause the first roller 110 to move away from the second roller 115 in a direction perpendicular to the first tangent line 120 (e.g., cause the first distance 225 to increase by 1-5%, 5-10%, 10-20% or greater than 20%). The battery active material 155 can impart a reaction force on the second roller 115 and the third roller 130 at the second pressure point 125 that can cause the second roller 115 to move away from the third roller 130 in a direction perpendicular to the second tangent line 135 (e.g., cause the second distance 250 to increase slightly). For example, actuators (e.g., a pneumatic actuator, a hydraulic actuator, a linear actuator, a rotation actuator, or other actuator) apply a force to the battery active material 155 to achieve a particular distance 225 or distance 250, to minimize any change in distances 225 and 250, or to otherwise control distances 225 and 250. For example, the actuators can apply a force to achieve a particular material thickness, density, or other parameter of the film formed at the first pressure point 105 or the second pressure point 125. Actuators can be used to apply a force the first roller 110, the second roller 115, or the third roller 130 to apply a pressure to the first pressure point 105, the second pressure point 125, or the third pressure point 140, for example. At least one of the first roller 110, the second roller 115, or the third roller 130 can transfer the first battery active material 155 from one pressure point (e.g., the first pressure point 105 or the second pressure point 125) to another pressure point (e.g., the second pressure point 125 or the third pressure point 140). For example, the second roller 115 can be a transfer roller upon which no external force is applied by an actuator. The second roller 115 can transfer the film formed by the battery active material 155 from the first pressure point 105 to the second pressure point 125.

Movement of a roller in a direction perpendicular to the respective tangent line can cause variances in a thickness or density of a material sheared through a pressure point. For example, if the first roller 110 moves closer to or further from the second roller 115 in a direction perpendicular to the first tangent line 120, the thickness of a film comprising battery active material 155 that is created at the first pressure point 105 will vary such that at least some portion of the film has a thickness other that is greater or less than a desired thickness. The second roller 115 can move closer to or further from the third roller 130 in a direction perpendicular to the second tangent line 135, which can cause the thickness of the second film comprising battery active material 155 that is created at the second pressure point 125 to vary such that at least some portion of the second film has a thickness other that is greater or less than a desired thickness. Because material variances are undesirable and can affect the properties of a battery in which electrodes are used, it is desirable to eliminate or mitigate undesired material variances.

The system 100 can include the second tangent line 135 that intersects the first tangent line 120. For example, the first tangent line 120 defined by the first roller 110 and the second roller 115 can extend in a first direction, such as a substantially vertical direction. The second tangent line 135 defined by the second roller 115 and the third roller 130 can extend in a second direction, such as a substantially horizontal direction. In this way, the first tangent line 120 and the second tangent line 135 are non-parallel and will thus intersect at some point in space. The first tangent line 120 can be perpendicular to the second tangent line 135. Because the first tangent line 120 and the second tangent line 135 are non-parallel, the battery active material 155 is sheared in a first direction (e.g., downwards) at the first pressure point 105 and in a second direction (e.g., to the right) at the second pressure point 125. For example, the battery active material 155 is not sheared or compressed in a vertical direction (e.g., upwards or downwards) at two consecutive pressure points. The direction in which the battery active material 155 is sheared or compressed changes from one pressure point to an adjacent pressure point.

Because the first tangent line 120 intersects the second tangent line 135, the first pressure point 105 is decoupled from the second pressure point 125. Because the second tangent line 135 intersects the first tangent line 120, the second pressure point 125 is decoupled from the first pressure point 105. Decoupled pressure points allows for each pressure point to be at least partially isolated from forces exerted at another pressure point, specifically adjacent pressure points. For example, the first pressure point 105 can be isolated from forces generated or imparted at the second pressure point 125 because the first tangent line 120 and the second tangent line 135 intersect. For example, the battery active material 155 can impart a reactionary force on the second roller 115 as the battery active material 155 is compressed at the second pressure point 125. Such reactionary forces can cause the second roller 115 to move slightly in a direction perpendicular to the second tangent line 135. However, because the first tangent line 120 intersects (e.g., is non-parallel with) the second tangent line 135, the movement of the second roller 115 will be in a direction that is not perpendicular to the first tangent line 120. A movement of the second roller 115 at the second pressure point 125 can avoid causing a movement of the second roller 115 at the first pressure point 105, as may occur if the first tangent line 120 was parallel with the second tangent line 135. For example, a movement of the second roller 115 at the second pressure point 125 can avoid causing a material variance to occur at the first pressure point 105.

The system 100 can include a fourth roller 145. The third roller 130 and the fourth roller 145 can define a third tangent line 192. The third roller 130 and the fourth roller 145 can define a third pressure point 140 between the third roller 130 and the fourth roller 145. For example, the third pressure point 140 can be a gap (e.g., a space, a nip, an opening) between the third roller 130 and the fourth roller 145 where an outer surface of the third roller 130 and an outer surface of the fourth roller 145 are closest (e.g., where a distance between an outer surface of the third roller 130 and an outer surface of the fourth roller 145 is smallest).

The fourth roller 145 can include a fourth roller diameter. For example, the fourth roller diameter is the same as (e.g., having identical dimensions), substantially similar to (e.g., having dimensions±15%) or different than the third roller diameter. The fourth roller 145 can rotate about a fourth axis in a fourth direction 146. The fourth axis can be parallel with the first axis, the second axis, and the third axis. The fourth direction 146 can be opposite the third direction 131. The fourth direction 146 can be the same as the second direction 116. The fourth roller 145 can rotate about the fourth axis at a fourth circumferential speed to achieve a fourth angular velocity. For example, the fourth circumferential speed can be different than the first circumferential speed or the second circumferential speed. The fourth circumferential speed can be 1.5 to four times greater than the first circumferential speed or the second circumferential speed. The fourth circumferential speed can be substantially similar to (e.g., ±15%) the third circumferential speed. The fourth angular velocity can be different than the first angular velocity or the second angular velocity, but substantially similar to (e.g., ±15%) the third angular velocity. The fourth angular velocity can be substantially similar to (e.g., ±15%) at least one of the first angular velocity and the second angular velocity.

The system 100 can include the third roller 130 and the fourth roller 145 to apply force (e.g., a compressive force, a laminating force, or some other force) to a film received between the third roller 130 and the fourth roller 145. For example, the third roller 130 and the fourth roller 145 can receive the battery active material 155 that has been sheared into the second film by the second roller 115 and the third roller 130 at the second pressure point 125. The third roller 130 and the fourth roller 145 can receive the battery active material 155 (e.g., the second film) at the third pressure point 140. For example, the third roller 130 and the fourth roller 145 can rotate inwards towards the third pressure point 140 to pull or draw the battery active material 155, which can be sheared into a second film at the second pressure point 125, into and through the third pressure point 140 between the third roller 130 and the fourth roller 145. As the battery active material 155 is drawn through the third pressure point 140, it can be compressed or laminated with a current collector material 194 to form an electrode film. Heat can be applied at the third pressure point 140 to facilitate a lamination operation.

The third roller 130 can rotate in the third direction 131 at the third speed and third angular velocity, while the fourth roller 145 can contra-rotate in the fourth direction 146 at the fourth speed and fourth angular velocity. The third speed or third angular velocity can be substantially similar (e.g., ±15%) to the fourth speed or fourth angular velocity, respectively. For example, the third speed can be substantially similar to the fourth speed such that no shearing force is created at the third pressure point 140. A compressive force or laminating force can be created at the third pressure point 140 with the third speed or third angular velocity being substantially similar (e.g., ±15%) to the fourth speed or fourth angular velocity, respectively. The third speed or third angular velocity can be less than or greater than the fourth speed or fourth angular velocity, respectively. For example, a difference in speed or angular velocity of the third roller 130 and the fourth roller 145 can create a shearing force that shears the battery active material 155 as it passes through the third pressure point 140. A force can be applied at the third pressure point 140 to compress the battery active material 155 with the current collector material 194. For example, the second film comprising the battery active material 155 and the current collector material 194 can be simultaneously compressed at the third pressure point 140.

The system 100 can include the third roller 130 and the fourth roller 145 to laminate a current collector material and the second film formed by the second roller 115 and the third roller 130. For example, the third roller 130 and the fourth roller 145 can receive the battery active material 155 that has been sheared into the second film by the second roller 115 and the third roller 130 at the second pressure point 125. The third roller 130 and the fourth roller 145 can receive the current collector material 194. The current collector material 194 can include a first side 195 and a second side 196. The current collector material 194 can be a thin film, such as a current collector foil. The current collector material 194 can be provided to the third pressure point 140 via at least one web handling device 199 (e.g., an idler, a roller, a guide). For example, the web handling device 199 can include one or more bearings that can allow the web handling device 199 to roll or spin as the current collector material 194 is provided to the third pressure point 140.

The third roller 130 and the fourth roller 145 can receive the battery active material 155 (e.g., the second film) and the current collector material 194 at the third pressure point 140. For example, the third roller 130 and the fourth roller 145 can rotate inwards towards the third pressure point 140 to pull or draw the battery active material 155, which can be sheared into a second film at the second pressure point 125, and the current collector material 194 into and through the third pressure point 140 between the third roller 130 and the fourth roller 145. As the battery active material 155 and the current collector material 194 are drawn through the third pressure point 140, the battery active material 155 can be laminated with the first side 195 of the current collector material 194 to form an electrode material 197. Herat and pressure (e.g., a compressive force) can be applied at the third pressure point 140 to laminate the battery active material 155 with the first side 195 of the current collector material 194. For example, the third pressure point 140 can be heated to a temperature of 50-200° C. The third pressure point 140 can be heated to a temperature of less than 50° C. or to a temperature greater than 200° C., for example. When laminated, the current collector material 194 and the battery active material 155 can be joined such that the battery active material 155 cannot easily be separated from the current collector material (e.g., without use of substantial force).

The third tangent line 192 can intersect the second tangent line 135. For example, the third tangent line 192 defined by the third roller 130 and the fourth roller 145 can extend in a first direction, such as a substantially vertical direction. The third tangent line 192 can extend in a direction that is substantially similar to (e.g., ±30 degrees) the first tangent line 120. The second tangent line 135 defined by the second roller 115 and the third roller 130 can extend in a second direction, such as a substantially horizontal direction. The third tangent line 192 and the second tangent line 135 can be non-parallel and can thus intersect at some point in space. The third tangent line 192 can be non-parallel with the second tangent line 135. For example, the third tangent line 192 can be perpendicular to the second tangent line 135. Because the third tangent line 192 and the second tangent line 135 are non-parallel, the battery active material 155 or current collector material 194 that can be compressed or laminated in a first direction (e.g., downwards) at the third pressure point 140, while the battery active material 155 can be sheared or compressed in a second direction (e.g., to the right) at the second pressure point 125.

The system 100 can include a first infeed device 150 to provide the battery active material 155 to the first roller 110 and the second roller 115. For example, the infeed device 150 can be a hopper device configured to provide a predefined or controlled amount of a dry powdered battery active material 155 at the first pressure point 105. The infeed device 150 can provide battery active material 155 to at least one of the first roller 110 or the second roller 115, where the rotation of the first roller 110 or the rotation of the second roller 115 cause the first roller 110 and the second roller 115 to draw the battery active material 155 through the first pressure point 105. For example, the infeed device 150 can provide battery active material 155 to the first pressure point 105 (e.g., to the first roller 110, the second roller 115, or otherwise) at a predefined rate such that an amount of battery active material 155 sheared or compressed through the first pressure point 105 remains substantially constant. For example, the infeed device 150 can include a reservoir or container configured to store battery active material 155 to be provided to the first pressure point 105. The infeed device 150 can provide battery active material 155 to another pressure point or to one or more rollers other than the first roller 110 or the second roller 115. For example, the infeed device 150 can provide the battery active material 155 to the first pressure point 105 (e.g., the outermost pressure point of the system 100 or some other system), to a surface of the first roller 110, to a surface of the second roller 115, or to both a surface of the first roller 110 and a surface of the second roller 115. The infeed device 150 can provide the battery active material 155 to another pressure point (e.g., the second pressure point 125). In various example, the infeed device 150 can provide the battery active material 155 to a single, outer-most roller of the system 100, such as the first roller 110. The infeed device 150 can provide the battery active material 155 to some other roller, for example.

The system 100 can include at least one web handling device 199 to provide the current collector material 194 to the third roller 130 and the fourth roller 145. For example, the web handling device 199 can apply or maintain a tension on the current collector material 194 such that the current collector material 194 remains taut or substantially wrinkle-free (e.g., ±95% wrinkle free) as the current collector material 194 is provided to the third pressure point 140. The current collector material 194 can be a thin film that is provided to the third pressure point 140. The current collector material 194 can be provided to the system 100 in a rolled form; the current collector material 194 can be a roll of current collector film that can be unrolled to provide the current collector film to the third pressure point 140. The unrolled current collector material 194 can be a film can be directed to the third pressure point 140 via a web handling device 199. The web handling device can include one or more bearings that can allow the web handling device 199 to roll or spin as the current collector material 194 is provided to or drawn from (when laminated with the battery active material 155, for example) the third pressure point 140. The web handling device 199 can include a rubberized or gripped surface or texture that can prevent the current collector material 194 from slipping or moving with respect to the web handling device 199 other than in the direction of rotation of the web handling device 199 (e.g., towards the third pressure point 140). The web handling device 199 can be or include an idler, roller, wheel, rotatable shaft, or other device. The web handling device 199 can be or include another device to pull or draw the current collector material 194 towards or away from the third pressure point 140. For example, the web handling device 199 can be or include at least one mechanical clamp or finger to grasp, pinch, guide, or pull the current collector material 194. For example, the mechanical clamp or finger can pull the current collector material 194 towards the third pressure point 140. The finger or mechanical claim can apply a tension to the current collector material 194 such that the current collector material 194 is taut (e.g., substantially free of wrinkles, creases, folds, etc.) as the current collector material 194 passes through the third pressure point 140. In various embodiments, including those without a finger or mechanical claim, the web handling device 199 can act to apply a tension to the current collector material 194 such that the current collector material 194 can be taut or without slack as it passes through the third pressure point 140.

The system 100 can include a fifth roller 165 and a sixth roller 170 that define a fourth tangent line 175. The fifth roller 165 and the sixth roller 170 can define a fourth pressure point 160 between the fifth roller 165 and the sixth roller 170. For example, the fourth pressure point 160 can be a gap (e.g., a space, a nip, an opening) between the fifth roller 165 and the sixth roller 170 where an outer surface of the fifth roller 165 and an outer surface of the sixth roller 170 are closest (e.g., where a distance between an outer surface of the fifth roller 165 and an outer surface of the sixth roller 170 is smallest).

The fifth roller 165 can have a fifth roller diameter. The sixth roller 170 can have a sixth roller diameter. For example, the fifth roller diameter is less than the sixth roller diameter. The sixth roller diameter can be 1.5 to two times greater than the fifth roller diameter. The fifth roller diameter can be the same as or substantially similar to (e.g., ±15%) the sixth roller diameter or another roller diameter (e.g., the fourth roller diameter, the first roller diameter, etc.). The fifth roller 165 can rotate about a fifth axis in a fifth direction 171. The sixth roller 170 can rotate about a sixth axis in a sixth direction 176. The fifth axis can be parallel with the sixth axis. The fifth direction 171 can be opposite the sixth direction 176. The fifth roller 165 can rotate about the fifth axis at a fifth circumferential speed to achieve a fifth angular velocity. The sixth roller 170 can rotate about the sixth axis at a sixth circumferential speed to achieve a sixth angular velocity. For example, the fifth circumferential speed can be different than the sixth circumferential speed. The sixth circumferential speed can be 1.5 to two times greater than the fifth circumferential speed. The fifth circumferential speed can be the same as or substantially similar to (e.g., ±15%) the sixth circumferential speed or another circumferential speed (e.g., the fourth circumferential speed). The fifth angular velocity can be different than the sixth angular velocity. For example, the sixth angular velocity can be 1.5 to two times greater than the fifth angular velocity. The fifth angular velocity can be the same as or substantially similar to (e.g., ±15%) the sixth angular velocity.

The system 100 can include the fifth roller 165 and the sixth roller 170 to apply force (e.g., a shearing force or a compressive force) to a second battery active material 190 (e.g., electrode active material) received between the fifth roller 165 and the sixth roller 170 to form a third film (e.g., electrode film). For example, the fifth roller 165 and the sixth roller 170 can rotate inwards towards the fourth pressure point 160 to pull or draw the second battery active material 190 into and through the fourth pressure point 160 between the fifth roller 165 and the sixth roller 170. As the second battery active material 190 is drawn through the fourth pressure point 160, it is compressed or sheared to form the third. For example, the fifth roller 165 can rotate in the fifth direction 171 at the fifth speed and fifth angular velocity, while the sixth roller 170 can contra-rotate in the sixth direction 176 at the sixth speed and sixth angular velocity, where the fifth speed or fifth angular velocity is less than the sixth speed or sixth angular velocity, respectively. A difference in speed or angular velocity of the fifth roller 165 and the sixth roller 170 can create a shearing force that can shear the second battery active material 190 as it passes through the fourth pressure point 160. For example, the third film comprising the second battery active material 190 is created as the second battery active material 190 is sheared through the fourth pressure point 160. For example, the third film can include a thickness that is proximate to the first distance 225 (e.g., the distance between the first roller 110 and the second roller 115 at the first pressure point 105). The gap between the fifth roller 165 and the sixth roller 170 at the fourth pressure point 160 can define a thickness of the third film. The gap between the fifth roller 165 and the sixth roller 170 can be adjusted to modify the thickness of the third film, for example. A compressive force can be applied at the fourth pressure point 160 to affect the thickness of the second battery active material 190. A speed differential between the fifth circumferential speed and the sixth circumferential speed can affect (e.g., reduce) a thickness of the third film. The second battery active material 190 can be material suitable to produce an anode electrode layer (e.g., anode 1315 of FIG. 13 and discussed below) or a cathode electrode layer (e.g., cathode 1325 of FIG. 13 and discussed below).

The system 100 can include the fourth roller 145 and the sixth roller 170 that define a fifth tangent line 180. The fourth roller 145 and the sixth roller 170 can define a fifth pressure point 185 between the fourth roller 145 and the sixth roller 170. For example, the fifth pressure point 185 can be a gap (e.g., a space, a nip, an opening) between the fourth roller 145 and the sixth roller 170 where an outer surface of the fourth roller 145 and an outer surface of the sixth roller 170 are closest (e.g., where a distance between an outer surface of the fourth roller 145 and an outer surface of the sixth roller 170 is smallest).

The system 100 can include the fourth roller 145 and the sixth roller 170 to apply force (e.g., a shearing force or a compressive force) to the third film received between the fourth roller 145 and the sixth roller 170. For example, the fourth roller 145 and the sixth roller 170 can receive the third film comprising the second battery active material 190 that has been sheared into a film by the fifth roller 165 and the sixth roller 170 at the fourth pressure point 160. The fourth roller 145 and the sixth roller 170 can receive the second battery active material 190 at the fifth pressure point 185. For example, the fourth roller 145 and the sixth roller 170 can rotate inwards towards the fifth pressure point 185 to pull or draw the third film into and through the fifth pressure point 185 between the fourth roller 145 and the sixth roller 170. As the third film is drawn through the fifth pressure point 185, it can be compressed or sheared to form a fourth film comprising the second battery active material 190. The fourth roller 145 can rotate in the fourth direction 146 at the fourth speed and fourth angular velocity, while the sixth roller 170 can contra-rotate in the sixth direction 176 at the sixth speed and sixth angular velocity. For example, the sixth speed or sixth angular velocity can be less than the fourth speed or fourth angular velocity, respectively. A difference in speed or angular velocity of the fourth roller 145 and the sixth roller 170 can create a shearing force that shears or compresses the third film as it passes through the fifth pressure point 185. The fourth film comprising the second battery active material 190 can be created as the third film created at the fourth pressure point 160 is sheared through the fifth pressure point 185. For example, the fourth film can include a thickness that is proximate to the second distance 250 (e.g., the distance between the second roller 115 and the third roller 130 at the second pressure point 125). The gap between the sixth roller 170 and the fourth roller 145 at the fifth pressure point 185 can define a thickness of the fourth film. The gap between the sixth roller 170 and the fourth roller 145 can be adjusted to modify the thickness of the fourth film, for example. A compressive force can be applied at the fifth pressure point 185 to affect a thickness of the second battery active material 190. A speed differential between the fourth circumferential speed and the sixth circumferential speed can affect (e.g., reduce) a thickness of the fourth film. The fourth film comprising the second battery active material 190 created by the fourth roller 145 and the sixth roller 170 at the fifth pressure point 185 can be thinner than the third film comprising the second battery active material 190 created by the fifth roller 165 and the sixth roller 170 at the fourth pressure point 160.

The system 100 can include a second infeed device 187 to provide the second battery active material 190 to the fifth roller 165 and the sixth roller 170. For example, the second infeed device 187 can be a hopper device configured to provide a predefined or controlled amount of a dry powdered second battery active material 190 at the fourth pressure point 160. The second infeed device 187 can provide the second battery active material 190 to at least one of the fifth roller 165 or the sixth roller 170, where the rotation of the fifth roller 165 or the rotation of the sixth roller 170 can draw or pull the second battery active material 190 through the fourth pressure point 160. For example, the second infeed device 187 can provide second battery active material 190 to the fourth pressure point 160 (e.g., between to the fifth roller 165 and the sixth roller 170, or otherwise) at a predefined rate such that an amount of second battery active material 190 sheared or compressed through the fourth pressure point 160 remains substantially constant. The second infeed device 187 can include a reservoir or container configured to store second battery active material 190 to be provided to the fourth pressure point 160. The second infeed device 187 can provide second battery active material 190 to another pressure point or to one or more rollers other than the fifth roller 165 or the sixth roller 170. For example, the second infeed device 187 can provide the second battery active material 190 to the fourth pressure point 160 (e.g., the outermost pressure point of the system 100 or some other system), to a surface of the fifth roller 165, to a surface of the sixth roller 170, or to a surface of the fifth roller 165 and a surface of the sixth roller 170. In various examples, the second infeed device 187 can provide the second battery active material 190 to a single, outer-most roller of the system 100, such as the first roller 110. The second infeed device 187 can provide the second battery active material 190 to some other roller, for example. The second infeed device 187 can provide the second battery active material 190 to another pressure point (e.g., the fifth pressure point 185).

The fourth roller 145, the fifth roller 165, and the sixth roller 170 can experience reaction forces as the second battery active material 190 passes through the fourth pressure point 160 or the fifth pressure point 185. For example, the second battery active material 190 can impart a reaction force on the fifth roller 165 and the sixth roller 170 at the fourth pressure point 160 that can cause the fifth roller 165 to move away from the sixth roller 170 in a direction perpendicular to the fourth tangent line 175, thereby causing a distance between the fifth roller 165 and the sixth roller 170 to increase. The second battery active material 190 can impart a reaction force on the fourth roller 145 or the sixth roller 170 at the fifth pressure point 185 that can cause the sixth roller 170 to move away from the fourth roller 145 in a direction perpendicular to the fifth tangent line 180, thereby causing a distance between the fourth roller 145 and the sixth roller 170 to increase. Actuators (e.g., a pneumatic actuator, a hydraulic actuator, a linear actuator, a rotation actuator, or other actuator) can be used to apply a force to the second battery active material 190 to achieve a particular distance between the fifth roller 165 and the sixth roller 170 or between the sixth roller 170 and the fourth roller 145, to minimize any change in distances between the fifth roller 165 and the sixth roller 170 or between the fourth roller 145 and the sixth roller 170, or to otherwise affect a distance between the fifth roller 165 and the sixth roller 170 or between the sixth roller 170 and the fourth roller 145. For example, the actuators can apply a force to achieve a particular material thickness, density, or other parameter of the film formed at the fourth pressure point 160 or the fifth pressure point 185. For example, the actuators can apply a force to achieve a particular material thickness, density, or other parameter of the film formed at the fourth pressure point 160 or the fifth pressure point 185. Actuators can be used to apply a force to the fourth roller 145, the fifth roller 165, or the sixth roller 170 to apply a pressure to the third pressure point 140, the fourth pressure point 160, or the fifth pressure point 185, for example. At least one of the fifth roller 165, the sixth roller 170, or the fourth roller 145 can transfer the second battery active material 190 from one pressure point (e.g., the fourth pressure point 160 or the fifth pressure point 185) to another pressure point (e.g., the fifth pressure point 185 or the third pressure point 140). For example, the sixth roller 170 can be a transfer roller upon which no (or minimal) external force is applied by an actuator. The sixth roller 170 can transfer the film formed by the second battery active material 190 from the fourth pressure point 160 to the fifth pressure point 185.

A movement of a roller in a direction perpendicular to the respective tangent line can cause variances in a thickness or density of a material sheared or compressed through a pressure point. For example, if the fifth roller 165 moves closer to or further from the sixth roller 170 in a direction perpendicular to the fourth tangent line 175, the thickness of a third film comprising the second battery active material 190 that is created at the fourth pressure point 160 can vary such that at least some portion of the third film has a thickness other that is greater or less than a desired thickness. The sixth roller 170 can move closer to or further from the fourth roller 145 in a direction perpendicular to the fifth tangent line 180, which can cause the thickness of the fourth film comprising the second battery active material 190 that is created at the fifth pressure point 185 to vary such that at least some portion of the fourth film has a thickness other that is greater or less than a desired thickness. Because material variances are undesirable and can affect the properties of a battery in which electrodes are used, it is desirable to eliminate or mitigate undesired material variances.

The system 100 can include the fourth tangent line 175 that intersects the fifth tangent line 180. For example, the fourth tangent line 175 defined by the fifth roller 165 and the sixth roller 170 can extend in a first direction, such as a substantially vertical direction. The fourth tangent line 175 extends in a direction that is substantially similar to (e.g., ±30 degrees) the direction of the first tangent line 120. The fifth tangent line 180 defined by the fourth roller 145 and the sixth roller 170 can extend in a second direction, such as a substantially horizontal direction. For example, the fifth tangent line 180 can extend in a direction that is substantially similar to (e.g., ±30 degrees) the direction of the second tangent line 135. The fourth tangent line 175 and the fifth tangent line 180 are non-parallel and will thus intersect at some point in space. The fourth tangent line 175 can be perpendicular to the fifth tangent line 180. Because the fourth tangent line 175 and the fifth tangent line 180 are non-parallel, the second battery active material 190 can be sheared or compressed in a first direction (e.g., downwards as shown in FIG. 1, among others) at the fourth pressure point 160 and in a second direction (e.g., to the left, as shown in FIG. 1, among others) at the fifth pressure point 185. The second battery active material 190 is not sheared or compressed in a vertical direction (e.g., upwards or downwards) at two consecutive pressure points. The direction in which the second battery active material 190 is sheared or compressed changes from one pressure point to an adjacent pressure point.

Because the fourth tangent line 175 can intersect the fifth tangent line 180, the fourth pressure point 160 can be decoupled from the fifth pressure point 185. Because the fifth tangent line 180 intersects the fourth tangent line 175, the fifth pressure point 185 is decoupled from the fourth pressure point 160. Decoupled pressure points allows for each pressure point to be at least partially isolated from forces exerted at another pressure point, specifically adjacent pressure points. For example, the fourth pressure point 160 can be isolated from forces generated or imparted at the fifth pressure point 185 because the fourth tangent line 175 and the fifth tangent line 180 intersect. For example, the second battery active material 190 can impart a reactionary force on the sixth roller 170 as the second battery active material 190 is compressed at the fifth pressure point 185. Such reactionary forces can cause the sixth roller 170 to move slightly in a direction perpendicular to the fifth tangent line 180. However, because the fourth tangent line 175 intersects (e.g., is non-parallel with) the fifth tangent line 180, the movement of the sixth roller 170 can be in a direction that is not perpendicular to the fourth tangent line 175. A movement of the sixth roller 170 at the fifth pressure point 185 can thus avoid causing a movement of the sixth roller 170 at the fourth pressure point 160, as would occur if the fourth tangent line 175 was parallel with the fifth tangent line 180. A movement of the sixth roller 170 at the fifth pressure point 185 can avoid causing a material variance to occur at the fourth pressure point 160.

The system 100 can include the third roller 130 and the fourth roller 145 to laminate the current collector material 194 with the second film formed by the second roller 115 and the third roller 130 and the fourth film formed by the fourth roller 145 and the sixth roller 170. For example, the third roller 130 and the fourth roller 145 can receive the second film at the third pressure point 140. The third roller 130 and the fourth roller 145 can receive the fourth film at the third pressure point 140. The third roller 130 and the fourth roller 145 can receive the current collector material 194. The third roller 130 and the fourth roller 145 can rotate inwards towards the third pressure point 140 to pull or draw the second film comprising the battery active material 155, the current collector material 194, and the fourth film comprising the second battery active material 190 into and through the third pressure point 140 between the third roller 130 and the fourth roller 145. For example, the second film can contact (e.g., abut, be adjacent to) the first side 195 of the current collector material 194 as the second film and the current collector material 194 enter the third pressure point 140. The fourth film can contact (e.g., abut, be adjacent to) the second side 196 of the current collector material 194 as the fourth film and the current collector material 194 enter the third pressure point 140. As the second film, the current collector material 194, and the fourth film are drawn through the third pressure point 140, the second film can be laminated with the first side 195 of the current collector material 194 and the fourth film can be laminated with the second side 196 of the current collector material 194 to form an electrode material 197. When laminated, second film comprising the battery active material 155, the current collector material 194, and the fourth film comprising the second battery active material 190 can be joined such that the second film or the fourth film cannot easily be separated from the current collector material 194 (e.g., without use of substantial force).

The system 100 can include the third tangent line 192 can intersect the fifth tangent line 180. For example, the third tangent line 192 defined by the third roller 130 and the fourth roller 145 can extend in a first direction, such as a substantially vertical direction. The third tangent line 192 can extend in a direction that is substantially similar to (e.g., ±30 degrees) the first tangent line 120 and the fourth tangent line 175. The fifth tangent line 180 defined by the fourth roller 145 and the sixth roller 170 can extend in a second direction, such as a substantially horizontal direction. In this way, the third tangent line 192 and the fifth tangent line 180 are non-parallel and will thus intersect at some point in space. The third tangent line 192 can be perpendicular to the fifth tangent line 180. Because the third tangent line 192 and the fifth tangent line 180 are non-parallel, the battery active material 155, current collector material 194, and second battery active material 190 that can be compressed or laminated in a first direction (e.g., downwards) at the third pressure point 140, while the second battery active material 190 can be sheared or compressed in a second direction (e.g., to the left) at the fifth pressure point 185.

The system 100 can be at least partially controlled by at least one data processing system 101. For example, the data processing system 101 can be communicably coupled with at least one component of the system 100, such as the first roller 110, the second roller 115, the third roller 130, the fourth roller 145, the fifth roller 165, the sixth roller 170, the infeed device 150, the second infeed device 187, an actuator (e.g., a pneumatic actuator, a hydraulic actuator, a linear actuator, a rotation actuator, or other actuator) coupled with a roller, a web handling device 199, a heating mechanism of a roller, or otherwise. The data processing system 101 can include a processor and a memory including instructions stored thereon. The instructions, when executed by the processor, cause the processor to control or influence an operation of a component of the system 100. For example, the data processing system 101 can control a temperature of the first roller 110 and the second roller 115. The data processing system 101 can control an actuator (e.g., a pneumatic actuator, a hydraulic actuator, a linear actuator, a rotation actuator, or other actuator) associated with the fifth roller 165 or the sixth roller 170 to apply a pressure to a material (e.g., the second battery active material 190) as it is sheared or compressed through the fourth pressure point 160. The data processing system 101 can control a speed or angular velocity of the third roller 130 or the fourth roller 145. The data processing system 101 can control an infeed rate of battery active material 155 at the first pressure point 105 via the infeed device 150. The data processing system 101 can control a temperature of the second infeed device 187 to heat the second battery material 190 before it is provided to the fourth pressure point 160. The data processing system 101 thus provides an operator with the ability to control various components of the system 100.

The first roller 110, the second roller 115, the third roller 130, the fourth roller 145, the fifth roller 165, or the sixth roller 170 can be heated (e.g., warmer than an ambient temperature) to facilitate a shearing, compression, or laminating operation at one or more of the first pressure point 105, the second pressure point 125, the third pressure point 140, the fourth pressure point 160, or the fifth pressure point 185. For example, the second roller 115 can include an outer surface that heated to at least partially melt or soften the battery active material 155 that passes through the first pressure point 105 or the second pressure point 125. The sixth roller 170 can include an outer surface that is heated to at least partially melt or soften the second battery active material 190 that passes through the fourth pressure point 160 or the fifth pressure point 185. The infeed device 150 or the second infeed device 187 can heat the battery active material 155 or second battery active material 190, respectively, before they are provided to the first pressure point 105 or fourth pressure point 160, respectively. The infeed device 150 and the second infeed device 187 can be at an ambient temperature (e.g., not heated) and can be structured to provide battery active material 155 and second battery active material 190 at an ambient temperature to the first pressure point 105 or the fourth pressure point 160, respectively. The infeed device 150 or the second infeed device 187 can be an extruder, a hopper, a heated roller, or some other device to provide the battery active material 155 or the second battery active material 190 to at least one pressure point (e.g., an outermost pressure point such as the first pressure point 105 or the fourth pressure point 160) of the system 100 or some other system.

The first roller 110, the second roller 115, the third roller 130, the fourth roller 145, the fifth roller 165, or the sixth roller 170 can be actuated by one or more actuators (e.g., a pneumatic actuator, a hydraulic actuator, a linear actuator, a rotation actuator, or other actuator) that apply a static or dynamic pressure at the respective pressure point. For example, the first roller 110 or the second roller 115 can be coupled with an actuator that can apply a force at first pressure point 105 to compress the battery active material 155 between the first roller 110 and the second roller 115 at the first pressure point 105. Force applied by the actuator at the first pressure point can cause the first roller 110 to move towards the second roller 115 at the first pressure point 105 in a direction perpendicular to the first tangent line 120 (e.g., cause the distance 225 to decrease slightly). The second roller 115 or the third roller 130 can be coupled with an actuator that can apply a force at the second pressure point 125 to compress the battery active material 155 (e.g., the film) between the second roller 115 and the third roller 130 at the second pressure point 125. For example, the an actuator can apply a force to the third roller 130 to compress a film formed by the battery active material 155 between the second roller 115 and the third roller 130, while the second roller 115 can be substantially free (e.g., ±95% free) from any external forces or decoupled from any actuator. As noted above, the second roller 115 can be a transfer roller that can act to transfer the film from the first pressure point 105 through the second pressure point 125. Force applied by the actuator at the second pressure point 125 can cause the third roller 130 to move towards the second roller 115 in a direction perpendicular to the second tangent line 135 (e.g., cause the distance 250 to decrease slightly), for example. Force applied by the actuator at the second pressure point 125 can cause the third roller 130 to otherwise move.

The third roller 130 or the fourth roller 145 can be coupled with an actuator (e.g., a pneumatic actuator, a hydraulic actuator, a linear actuator, a rotation actuator, or other actuator) that can apply a force at the third pressure point 140 to compress the second film, current collector material, and fourth film between the third roller 130 and the fourth roller 145. Force applied by the actuator at the third pressure point 140 can cause the third roller 130 to move towards the fourth roller 145 in a direction perpendicular to the third tangent line 192 and can facilitate a lamination operation at the third pressure point 140. In this example, at least one of the third roller 130 or the fourth roller 145 can be heated to further facilitate the bonding or joining of the second film, the current collector material 194, and the fourth film during a lamination operation.

The fifth roller 165 or the sixth roller 170 can be coupled with an actuator (e.g., a pneumatic actuator, a hydraulic actuator, a linear actuator, a rotation actuator, or other actuator) that can apply a force at the fourth pressure point 160 to compress the second battery active material 190 between the fifth roller 165 and the sixth roller 170. For example, a force can be applied by the actuator at the fourth pressure point 160. The actuator can apply a force to the fifth roller 165 or the sixth roller 170 to achieve a particular distance between the fifth roller 165 and the sixth roller 170 or between the sixth roller 170 and the fourth roller 145, to minimize any change in distances between the fifth roller 165 and the sixth roller 170 or between the fourth roller 145 and the sixth roller 170, or to otherwise affect a distance between the fifth roller 165 and the sixth roller 170 or between the sixth roller 170 and the fourth roller 145. The actuator can apply a force to the fifth roller 165 or the sixth roller 170 to achieve a particular material thickness, density, or other parameter of the film formed by the second battery active material 190 at the fourth pressure point 160 or the fifth pressure point 185. Force applied by the actuator at the fourth pressure point 160 can cause the fifth roller 165 to move towards the sixth roller 170 in a direction perpendicular to the fourth tangent line 175. The fourth roller 145 or the sixth roller 170 can be coupled with an actuator that can apply a force at the fifth pressure point 185 to compress the second battery active material 190 (e.g., the third film) between the fourth roller 145 and the sixth roller 170. Force applied by the actuator at the fifth pressure point 185 can cause the fourth roller 145 to move towards the sixth roller 170 in a direction perpendicular to the fifth tangent line 180, for example. Force applied at the fifth pressure point 185 can cause the fourth roller 145 or the sixth roller 170 to otherwise move. At least one of the fifth roller 165, the sixth roller 170, or the fourth roller 145 can transfer the second battery active material 190 from one pressure point (e.g., the fourth pressure point 160 or the fifth pressure point 185) to another pressure point (e.g., the fifth pressure point 185 or the third pressure point 140). The sixth roller 170 can be a transfer roller that rotates to transfer material from the fourth pressure point 160 to the fifth pressure point 185 as external forces are applied to it. For example, a force imparted by the second battery active material 190, an actuator acting on the fifth roller 165, or an actuator acting on the fourth roller 145, can be indirectly imparted on the sixth roller 170. However, the sixth roller 170 can rotate from a fixed position such that the sixth roller 170 does not move away from the fifth roller 165, away from the fourth roller 145, or in some other direction. Rather, the sixth roller 170 can transfer the film formed by the second battery active material 190 from the fourth pressure point 160 to the fifth pressure point 185 without moving from a fixed point of rotation.

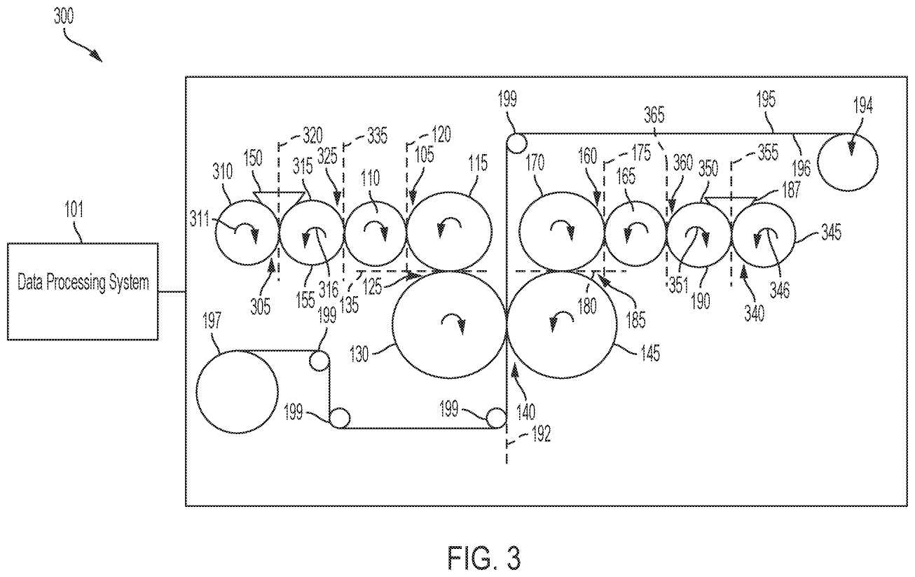

FIGS. 3-5, among others, depict a system 300 for manufacturing an electrode is shown. The system can produce an electrode for a battery. For example, the system 300 can produce an electrode for a rechargeable battery of an electric vehicle, such as an electric truck or electric sport utility vehicle (SUV). Among other examples, the system 300 can produce electrodes for a lithium ion (Li-ion) battery. The system 300 can produce a cathode electrode or an anode electrode that, when used in a battery, can receive electrical current or release electrons. For example, the system 300 can receive a dry powdered material as an input and can produce an electrode including at least one battery active layer joined with (e.g., laminated with) a current collector material. The system 300 can produce an electrode including a first film joined with a first side of a current collector material and a second film joined with a second side of the current collector material.

The system 300 can include the first roller 110, the second roller 115, the third roller 130, the fourth roller 145, the fifth roller 165, and the sixth roller 170 as described above with reference to FIG. 1 and FIG. 2, among others. The system 300 can also include the first pressure point 105, the first tangent line 120, the second pressure point 125, the second tangent line 135, the third pressure point 140, the third tangent line 192, the fourth pressure point 160, the fourth tangent line 175, the fifth pressure point 185, and the fifth tangent line 180 as described above with reference to FIG. 1 and FIG. 2, among others. The system 300 can also include the current collector material 194. The system 300 can produce the battery electrode 197.

The system 300 can include a seventh roller 310 and an eighth roller 315 that define a sixth tangent line 320. The seventh roller 310 and the eighth roller 315 can define a sixth pressure point 305 between the seventh roller 310 and the eighth roller 315. For example, the sixth pressure point 305 can be a gap (e.g., a space, a nip, an opening) between the seventh roller 310 and the eighth roller 315 where an outer surface of the seventh roller 310 and an outer surface of the eighth roller 315 are closest (e.g., where a distance between an outer surface of the seventh roller 310 and an outer surface of the eighth roller 315 is smallest).

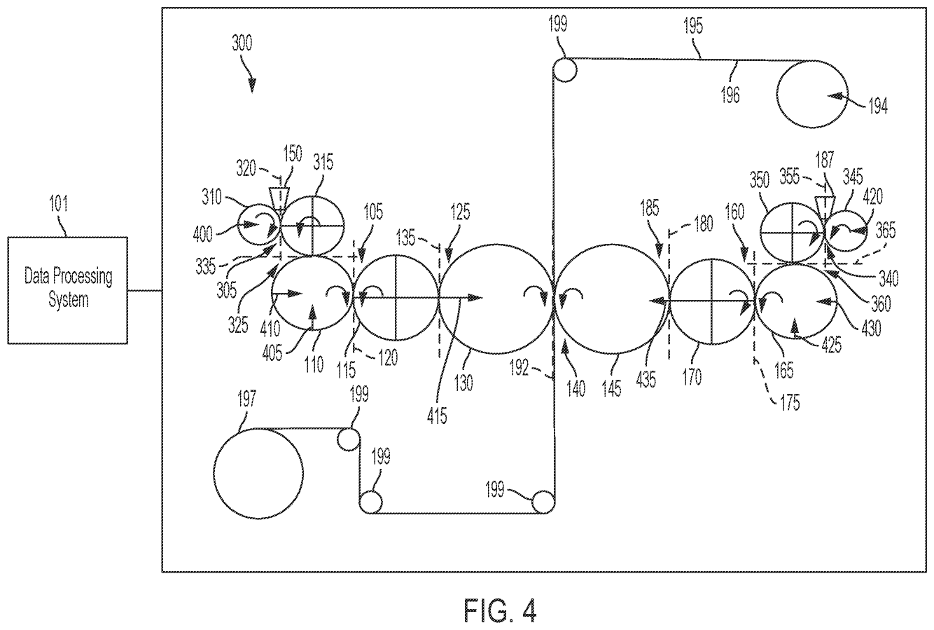

The seventh roller 310 can have a seventh roller diameter. The eighth roller 315 can have an eighth roller diameter. For example, such as that shown in FIG. 4, the seventh roller diameter is different than the eighth roller diameter. The eighth roller diameter can be 1.5 to two times greater than the seventh roller diameter. The seventh roller diameter can be the same as or substantially similar to (e.g., ±15%) the eighth roller diameter. The seventh roller diameter or the eighth roller diameter can be the same as (e.g., have identical dimensions), similar to (e.g., ±15%) or different from the first roller diameter of the first roller 110, the second roller diameter of the second roller 115, or the third roller diameter of the third roller 130, for example. The seventh roller 310 can rotate about a seventh axis in a seventh direction 311. The eighth roller 315 can rotate about an eighth axis in an eighth direction 316. The seventh axis can be parallel with the eighth axis. The seventh direction 311 can be opposite the eighth direction 316. The seventh roller 310 can rotate about the seventh axis at a seventh circumferential speed to achieve a seventh angular velocity. The eighth roller 315 can rotate about the eighth axis at an eighth circumferential speed to achieve an eighth angular velocity. The seventh circumferential speed can be different than the eighth circumferential speed. For example, the eighth circumferential speed can be 1.5 to two times greater than the seventh circumferential speed. The seventh circumferential speed can be the same as or substantially similar to (e.g., ±15%) the eighth circumferential speed. The seventh angular velocity can be different than the eighth angular velocity. For example, the eighth angular velocity can be 1.5 to two times greater than the seventh angular velocity. The eighth angular velocity can be more than two times greater than the seventh angular velocity. In other examples, the seventh angular velocity can be the same as or substantially similar (e.g., ±15%) to the eighth angular velocity.

The system 300 can include the seventh roller 310 and the eighth roller 315 to apply force (e.g., a shearing force or a compressive force) to the first battery active material 155 received between the seventh roller 310 and the eighth roller 315 to form a film. For example, the seventh roller 310 and the eighth roller 315 can rotate inwards towards the sixth pressure point 305 to pull or draw the battery active material 155 into and through the sixth pressure point 305 between the seventh roller 310 and the eighth roller 315. As the battery active material 155 is drawn through the sixth pressure point 305, it can be compressed or sheared to form a film. The seventh roller 310 can rotate in the seventh direction 311 at the seventh speed and seventh angular velocity, while the eighth roller 315 can contra-rotate in the eighth direction 316 at the eighth speed and eighth angular velocity, where the seventh speed or seventh angular velocity is less than the eighth speed or eighth velocity, respectively. A difference in speed or angular velocity of the seventh roller 310 and the eighth roller 315 can create a shearing force that shears the battery active material 155 as it passes through the sixth pressure point 305. For example, a fifth film comprising the battery active material 155 can be created as the battery active material 155 is sheared through the sixth pressure point 305.

The system 300 can include the first roller 110 and the eighth roller 315 that define a seventh tangent line 335. The first roller 110 and the eighth roller 315 can define a seventh pressure point 325 between the first roller 110 and the eighth roller 315. For example, the seventh pressure point 325 can be a gap (e.g., a space, a nip, an opening) between the first roller 110 and the eighth roller 315 where an outer surface of the first roller 110 and an outer surface of the eighth roller 315 are closest (e.g., where a distance between an outer surface of the first roller 110 and an outer surface of the eighth roller 315 is smallest).

The eighth roller 315 can rotate in the eighth direction 316 that is opposite the first direction 111. For example, the first circumferential speed of the first roller 110 can be different than the eighth circumferential speed of the eighth roller 315. For example, the eighth circumferential speed can be greater than or less than the first circumferential speed. The eighth circumferential speed can be the same as or substantially similar to (e.g., ±15%) the first circumferential speed. The first angular velocity of the first roller 110 can be different than the eighth angular velocity of the eighth roller 315. For example, the first angular velocity of the first roller 110 can be faster than the eighth angular velocity of the eighth roller 315. The first angular velocity of the first roller 110 can be the same as or substantially similar to the eighth angular velocity of the eighth roller 315.

The system 300 can include the first roller 110 and the eighth roller 315 to apply force (e.g., a shearing force or a compressive force) to the first battery active material 155 received between the first roller 110 and the eighth roller 315 to form a sixth film. For example, the first roller 110 and the eighth roller 315 can rotate inwards towards the seventh pressure point 325 to pull or draw the fifth film comprising the battery active material 155 into and through the seventh pressure point 325 between the first roller 110 and the eighth roller 315. As the fifth film is drawn through the seventh pressure point 325, it can be compressed or sheared to form the sixth film. For example, the first roller 110 can rotate in the first direction 111 at the first speed and first angular velocity, while the eighth roller 315 can contra-rotate in the eighth direction 316 at the eighth speed and eighth angular velocity, where the first speed or first angular velocity is greater than the eighth speed or eighth velocity, respectively. A difference in speed or angular velocity of the first roller 110 and the eighth roller 315 can create a shearing force that shears the fifth film comprising the battery active material 155 as it passes through the seventh pressure point 325. The seventh roller 310 or the eighth roller 315 can be heated rollers as described above with reference to the first roller 110, for example. The seventh roller 310 or the eighth roller 315 can be coupled with an actuator that can apply a force to the seventh roller 310, the eighth roller 315, or the first roller 110 to create a compression force at the sixth pressure point 305 or the seventh pressure point 325 as discussed above with reference to first roller 110 and the second roller 115, for example. The seventh roller 310 or the eighth roller 315 can be transfer rollers that are not coupled with any actuator and are not directly acted upon by any actuator. For example, the eighth roller 315 can be a transfer roller that transfers material from the sixth pressure point 305 towards the seventh pressure point 325. In other examples, the seventh roller 310 or both the seventh roller 310 and the eighth roller 315 can be transfer rollers, where transfer rollers can be decoupled from any actuator or other device and may instead rotate from a stationary position.

The sixth film comprising the battery active material 155 can be provided to the first roller 110 and the second roller 115 at the first pressure point 105. For example, rather than receiving battery active material 155 from the infeed device 150 as discussed above with reference to FIG. 1, among others, the first roller 110 and the second roller 115 can receive the sixth film comprising the battery active material 155 that has been sheared or compressed by the seventh roller 310, the eighth roller 315, and the first roller 110 at the sixth pressure point 305 and the seventh pressure point 325. In such examples, the infeed device 150 can provide the battery active material 155 to the seventh roller 310 and the eighth roller 315, rather than to the first roller 110 and the second roller 115.

As shown in FIG. 3, among others, the sixth tangent line 320 and the seventh tangent line 335 can be parallel. For example, the sixth tangent line 320 can extend in a first direction (e.g., vertically) while the seventh tangent line 335 can also extend in the first direction. The sixth tangent line 320 and the seventh tangent line 335 can be non-parallel. The battery active material 155 can be compressed or sheared through the sixth pressure point 305 in a downwards direction along the substantially vertical sixth tangent line 320. The battery active material 155 (e.g., the fifth film) can then be compressed or sheared through the seventh pressure point 325 in an upwards direction along the substantially vertical seventh tangent line 335. In this way, the sixth pressure point 305 and the seventh pressure point 325, which can be adjacent pressure points, can compress or shear the battery active material 155 in a substantially vertical direction. As discussed above, the first tangent line 120 of the first pressure point 105 can extend in a substantially vertical direction as well. The system 300 can have a first pressure point 105, a sixth pressure point 305, and a seventh pressure point 325 that are not decoupled. For example, the first tangent line 120, the sixth tangent line 320, and the seventh tangent line 335 can be parallel. The system 300 or other systems for manufacturing battery electrodes can thus include at least some pressure points that are decoupled (e.g., the second pressure point 125 can be decoupled from the third pressure point 140) and at least some pressure points that are not decoupled (e.g., the sixth pressure point 305 can have a sixth tangent line 320 that is parallel with seventh tangent line 335 of the seventh pressure point 325).

As shown in FIG. 4, among others, the system 300 can include at least one pressure point that is not decoupled from at least one other pressure point. For example, the sixth pressure point 305 can be decoupled from the seventh pressure point 325, while the first pressure point 105, the second pressure point 125, and the third pressure point 140 can configured to not be decoupled. As shown in FIG. 4, the system 300 can include the sixth pressure point 305 defining the sixth tangent line 320 that extends in a substantially vertical orientation (e.g., ±30 degrees from vertical). The system 300 can include the seventh pressure point 325 defining the seventh tangent line 335 that extends in a substantially horizontal orientation (e.g., ±30 degrees from horizontal). The sixth pressure point 305 can be decoupled from the seventh pressure point 325. The system 300 can include the sixth pressure point 305 decoupled from the seventh pressure point 325 to isolate forces at the sixth pressure point 305 from forces exerted at other pressure points (e.g., the seventh pressure point 325 or the first pressure point 105. The system 300 can include the first pressure point 105 not decoupled from the second pressure point 125. The system 300 can include the second pressure point 125 not decoupled from the third pressure point 140. The first tangent line 120 can be parallel with the second tangent line 135. The second tangent line 135 can be parallel with the third tangent line 192.

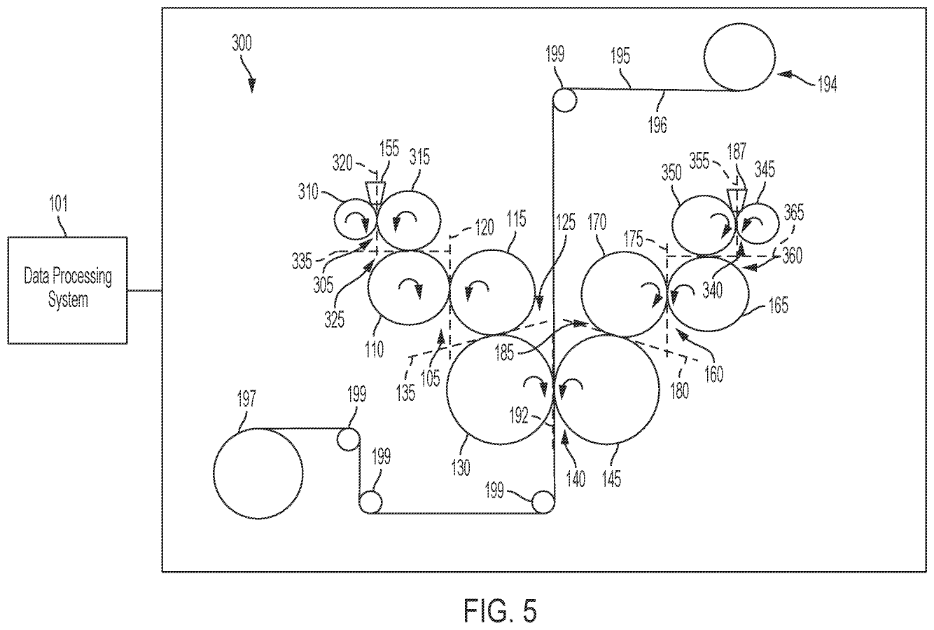

As shown in FIG. 5, among others, the system 300 can include multiple pressure points that can be decoupled from each other. For example, the system 300 can include the sixth pressure point 305 decoupled from the seventh pressure point 325. The system 300 can include the sixth tangent line 320 extending in a substantially vertical direction (e.g., ±30 degrees from vertical) and the seventh tangent line 335 extending in a substantially horizontal direction (e.g., ±30 degrees from horizontal). The system 300 can include the seventh pressure point 325 decoupled from the first pressure point 105. For example, the system 300 can include the seventh tangent line 335 extending in a substantially horizontal (e.g., ±30 degrees from horizontal) direction and the first tangent line 120 extending in a substantially vertical (e.g., ±30 degrees from vertical) direction. The system 300 can include the first pressure point 105 decoupled from the second pressure point 125. For example, the system can include the first tangent line 120 extending in a substantially vertical (e.g., ±30 degrees from vertical) direction and the second tangent line 135 extending at some angle with respect to the first tangent line 120 (e.g., 15-75 degrees). The system 300 can include the second pressure point 125 decoupled from the third pressure point 140. For example, the system 300 can include the third tangent line 192 extending at some angle with respect to the second tangent line 135 (e.g., 15-75 degrees).

The system 300 can include a ninth roller 345 and a tenth roller 350 that define an eighth tangent line 355. The ninth roller 345 and the tenth roller 350 can define an eighth pressure point 340 between the ninth roller 345 and the tenth roller 350. For example, the eighth pressure point 340 can be a gap (e.g., a space, a nip, an opening) between the ninth roller 345 and the tenth roller 350 where an outer surface of the ninth roller 345 and an outer surface of the tenth roller 350 are closest (e.g., where a distance between an outer surface of the ninth roller 345 and an outer surface of the tenth roller 350 is smallest).

The ninth roller 345 can have a ninth roller diameter. The tenth roller 350 can have a tenth roller diameter. For example, as shown in FIG. 4, the ninth roller diameter can be different than the tenth roller diameter. The tenth roller diameter can be 1.5 to two times greater than the ninth roller diameter. The ninth roller diameter can be the same as or substantially similar to (e.g., ±15%) the tenth roller diameter, as shown in FIG. 3. The ninth roller diameter or the tenth roller diameter can be the same as (e.g., having identical dimensions), similar to (e.g., ±15%), or different from the fifth roller diameter of the fifth roller 165, the sixth roller diameter of the sixth roller 170, or the fourth roller diameter of the fourth roller 145, for example. The ninth roller 345 can rotate about a ninth axis in a ninth direction 346. The tenth roller 350 can rotate about a tenth axis in a tenth direction 351. The ninth axis can be parallel with the tenth axis. The ninth direction 346 can be opposite the tenth direction 351. The ninth roller 345 can rotate about the ninth axis at a ninth circumferential speed to achieve a ninth angular velocity. The tenth roller 350 can rotate about the tenth axis at a tenth circumferential speed to achieve a tenth angular velocity. For example, the ninth circumferential speed can be different than the tenth circumferential speed. The tenth circumferential speed can be 1.5 to two times greater than the ninth circumferential speed. The ninth circumferential speed can be the same as or substantially similar to (e.g., ±15%) the tenth circumferential speed. The ninth angular velocity can be different than the tenth angular velocity. For example, the tenth angular velocity can be 1.5 to two times greater than the ninth angular velocity. The tenth angular velocity can be more than two times greater than the ninth angular velocity. In other examples, the ninth angular velocity can be the same as or substantially similar to (e.g., ±15%) the tenth angular velocity or some other angular velocity (e.g., the fifth angular velocity).

The system 300 can include the ninth roller 345 and the tenth roller 350 to apply force (e.g., a shearing force or a compressive force) to the second battery active material 190 received between the ninth roller 345 and the tenth roller 350 to form a seventh film. For example, the ninth roller 345 and the tenth roller 350 can rotate inwards towards the eighth pressure point 340 to pull or draw the second battery active material 190 into and through the eighth pressure point 340 between the ninth roller 345 and the tenth roller 350. As the second battery active material 190 is drawn through the eighth pressure point 340, it can be compressed or sheared to form the seventh film. The ninth roller 345 can rotate in the ninth direction 346 at the ninth speed and ninth angular velocity, while the tenth roller 350 can contra-rotate in the tenth direction 351 at the tenth speed and tenth angular velocity, where the ninth speed or ninth angular velocity is less than the tenth speed or tenth velocity, respectively. A difference in circumferential speed or angular velocity of the ninth roller 345 and the tenth roller 350 can create a shearing force that shears the second battery active material 190 as it passes through the eighth pressure point 340.

The system 300 can include the fifth roller 165 and the tenth roller 350 that define a ninth tangent line 365. The fifth roller 165 and the tenth roller 350 can define a ninth pressure point 360 between the fifth roller 165 and the tenth roller 350. For example, the ninth pressure point 360 can be a gap (e.g., a space, a nip, an opening) between the fifth roller 165 and the tenth roller 350 where an outer surface of the fifth roller 165 and an outer surface of the tenth roller 350 are closest (e.g., where a distance between an outer surface of the fifth roller 165 and an outer surface of the tenth roller 350 is smallest).

The tenth roller 350 can rotate in the tenth direction 351 that is opposite the fifth direction 171. For example, the fifth circumferential speed of the fifth roller 165 can be different than the tenth circumferential speed of the tenth roller 350. The fifth circumferential speed can be greater than or less than the tenth circumferential speed. The fifth circumferential speed can be the same as or substantially similar to (e.g., ±15%) the tenth circumferential speed. The fifth angular velocity of the fifth roller 165 can be different than the tenth angular velocity of the tenth roller 350. The fifth angular velocity of the fifth roller 165 can be greater than the tenth angular velocity of the tenth roller 350. The fifth angular velocity can be the same as or substantially similar to the tenth angular velocity (e.g., ±15%).

The system 300 can include the fifth roller 165 and the tenth roller 350 to apply force (e.g., a shearing force or a compressive force) to the second battery active material 190 received between the fifth roller 165 and the tenth roller 350 to form an eighth film. For example, the fifth roller 165 and the tenth roller 350 can rotate inwards towards the ninth pressure point 360 to pull or draw the seventh film comprising the second battery active material 190 into and through the ninth pressure point 360 between the fifth roller 165 and the tenth roller 350. As the seventh film is drawn through the ninth pressure point 360, it can be compressed or sheared to form the eighth film. The fifth roller 165 can rotate in the fifth direction 171 at the fifth speed and fifth angular velocity, while the tenth roller 350 can contra-rotate in the tenth direction 351 at the tenth speed and tenth angular velocity, where the fifth speed or fifth angular velocity can be greater than the tenth speed or tenth velocity, respectively. A difference in speed or angular velocity of the fifth roller 165 and the tenth roller 350 can create a shearing force that shears the seventh film comprising the second battery active material 190 as it passes through the ninth pressure point 360. The ninth roller 345 or the tenth roller 350 can be heated rollers as described above with reference to the fifth roller 165, for example. The ninth roller 345 or the tenth roller 350 can be coupled with an actuator that can apply a force to the ninth roller 345, the tenth roller 350, or the fifth roller 165 to create a compression force at the eighth pressure point 340 or the ninth pressure point 360 as discussed above with reference to fifth roller 165 and the sixth roller 170, for example. The ninth roller 345 or the tenth roller 350 can be transfer rollers that are not coupled with any actuator and are not directly acted upon by any actuator. For example, the tenth roller 350 can be a transfer roller that transfers material from the eighth pressure point 340 towards the ninth pressure point 360. In other examples, the ninth roller 345 or both the ninth roller 345 and the tenth roller 350 can be transfer rollers, where transfer rollers can be decoupled from any actuator or other device and may instead rotate from a stationary position.

The eighth film comprising the second battery active material 190 can be provided to the fifth roller 165 and the sixth roller 170 at the fourth pressure point 160. For example, rather than receiving the second battery active material 190 from the second infeed device 187 as discussed above with reference to FIG. 1, among others, the fifth roller 165 and the sixth roller 170 can receive the eighth film comprising the second battery active material 190 that has been sheared or compressed by the ninth roller 345, the tenth roller 350, and the fifth roller 165 at the eighth pressure point 340 and the ninth pressure point 360. In such examples, the second infeed device 187 can provide the second battery active material 190 to the ninth roller 345 and the tenth roller 350, rather than to the fifth roller 165 and the sixth roller 170.

As shown in FIG. 3, among others, the eighth tangent line 355 and the ninth tangent line 365 can be parallel. For example, the eighth tangent line 355 can extend in a first direction (e.g., vertically) and the ninth tangent line 365 can also extend in the first direction. The second battery active material 190 can be compressed or sheared through the eighth pressure point 340 in a downwards direction along the substantially vertical eighth tangent line 355. The second battery active material 190 (e.g., the seventh film) can then be compressed or sheared through the ninth pressure point 360 in an upwards direction along the substantially vertical ninth tangent line 365. In this way, the eighth pressure point 340 and the ninth pressure point 360, which can be adjacent pressure points, can compress or shear the second battery active material 190 in a substantially vertical direction (e.g., ±30 degrees from vertical). As discussed above, the fourth tangent line 175 of the fourth pressure point 160 can extend in a substantially vertical direction (e.g., ±30 degrees from vertical). The system 300 can have a fourth pressure point 160, an eighth pressure point 340, and a ninth pressure point 360 that are not decoupled. For example, the eighth tangent line 355 and the ninth tangent line 365 can be parallel. The system 300 or other systems for manufacturing battery electrodes can include at least some pressure points that are decoupled (e.g., the fifth pressure point 185 can be decoupled from the third pressure point 140) and at least some pressure points that are not decoupled (e.g., the eighth pressure point 340 can have an eighth tangent line 355 that is parallel with ninth tangent line 365 of the ninth pressure point 360).

As shown in FIG. 4, among others, the system 300 can include at least one pressure point that is not decoupled from at least one other pressure point. For example, the eighth pressure point 340 can be decoupled from the ninth pressure point 360, while the fourth pressure point 160, the fifth pressure point 185, and the third pressure point 140 can configured to not be decoupled. As shown in FIG. 4, the system 300 can include the eighth pressure point 340 defining the eighth tangent line 355 that extends in a substantially vertical orientation (e.g., ±30 degrees from vertical). The system 300 can include the ninth pressure point 360 defining the ninth tangent line 365 that extends in a substantially horizontal orientation (e.g., ±30 degrees from horizontal). The eighth pressure point 340 can be decoupled from the ninth pressure point 360. The system 300 can include the eighth pressure point 340 decoupled from the ninth pressure point 360 to isolate forces at the eighth pressure point 340 from forces exerted at other pressure points (e.g., the ninth pressure point 360 or the fourth pressure point 160). The system 300 can include the fourth pressure point 160 not decoupled from the fifth pressure point 185. The system 300 can include the fifth pressure point 185 not decoupled from the third pressure point 140. The fourth tangent line 175 can be parallel with the fifth tangent line 180. The fifth tangent line 180 can be parallel with the third tangent line 192.

As shown in FIG. 5, among others, the system 300 can include multiple pressure points that are decoupled from each other. For example, the system 300 can include the eighth pressure point 340 decoupled from the ninth pressure point 360. The system 300 can include the eighth tangent line 355 extending in a substantially vertical direction (e.g., ±30 degrees from vertical) and the ninth tangent line 365 extending in a substantially horizontal direction (e.g., ±30 degrees from horizontal). The system 300 can include the ninth pressure point 360 decoupled from the fourth pressure point 160. For example, the system 300 can include the ninth tangent line 365 extending in a substantially horizontal (e.g., ±30 degrees from horizontal) direction and the fourth tangent line 175 extending in a substantially vertical (e.g., ±30 degrees from vertical) direction. The system 300 can include the fourth pressure point 160 decoupled from the fifth pressure point 185. For example, the system can include the fourth tangent line 175 extending in a substantially vertical (e.g., ±30 degrees from vertical) direction and the fifth tangent line 180 extending at some angle with respect to the fourth tangent line 175 (e.g., 15-75 degrees). The system 300 can include the fifth pressure point 185 decoupled from the third pressure point 140. For example, the system 300 can include the third tangent line 192 extending at some angle with respect to the fifth tangent line 180 (e.g., 15-75 degrees).

The seventh roller 310, the eighth roller 315, the ninth roller 345, the tenth roller 350, and any other rollers can be moveable or dynamic such that the arrangement of rollers in the system 300, among others, can be varied. For example, the seventh roller 310 and the eighth roller 315 can be moved such that the eighth roller 315 can be positioned above the first roller 110. The seventh pressure point 325 can be oriented substantially horizontally (e.g., ±30 degrees from horizontal) between the first roller 110 and the eighth roller 315 rather than substantially vertical (e.g., ±30 degrees from vertical). In such examples, the sixth pressure point 305 can remain substantially vertical (e.g., ±30 degrees from vertical). By moving the seventh roller 310 and the eighth roller 315, the sixth pressure point 305 can be decoupled from the eighth pressure point 340, and the eighth pressure point 340 can be decoupled from the first pressure point 105.

The ninth roller 345 and the tenth roller 350 can be moved such that the tenth roller 350 can be positioned above the fifth roller 165. The ninth pressure point 360 can be oriented substantially horizontally (e.g., ±30 degrees from horizontal) between the fifth roller 165 and the tenth roller 350 rather than substantially vertical (e.g., ±30 degrees from vertical). In such examples, the eighth pressure point 340 can remain substantially vertical (e.g., ±30 degrees from vertical). By moving the ninth roller 345 and the tenth roller 350, the eighth pressure point 340 can be decoupled from the ninth pressure point 360, and the ninth pressure point 360 can be decoupled from the fourth pressure point 160. Because the various rollers can be reoriented from a coupled orientation to a decoupled orientation or from a decoupled orientation to a coupled orientation, the arrangement of rollers of the system 300 (or other systems) can be moveable or dynamic. Accordingly, various embodiments of the system 300, among others, are contemplated, where each embodiment can include pressure points and rollers in a coupled (e.g., linear) orientation, a decoupled orientation, or some combination thereof.

The first roller 110, the second roller 115, the third roller 130, the fourth roller 145, the fifth roller 165, the sixth roller 170, the seventh roller 310, the eighth roller 315, the ninth roller 345, or the tenth roller 350 can be actuated by one or more actuators (e.g., a pneumatic actuator, a hydraulic actuator, a linear actuator, a rotation actuator, or other actuator) that can apply a constant or dynamic pressure at the respective pressure point. For example, the seventh roller 310 can be coupled with an actuator that can apply a seventh force 400 at sixth pressure point 305 to compress the battery active material 155 between the seventh roller 310 and the eighth roller 315 at the sixth pressure point 305. The force 400 applied by the actuator at the sixth pressure point 305 can cause the seventh roller 310 to move towards the eighth roller 315 at the sixth pressure point 305 in a direction perpendicular to the sixth tangent line 320 (e.g., cause the distance between the seventh roller 310 and the eighth roller 315 to decrease slightly). The eighth roller 315 can be a transfer roller. For example, no actuator can apply a force to the eighth roller 315 such that the eighth roller 315 acts to transfer the battery active material 155 from the sixth pressure point 305 to the seventh pressure point 325. The eighth roller 315 can remain static as forces (e.g., the force 400) are applied to adjacent rollers.

The first roller 110 can be coupled with at least one actuator (e.g., a pneumatic actuator, a hydraulic actuator, a linear actuator, a rotation actuator, or other actuator) that can apply a constant or dynamic pressure to the seventh pressure point 325 or to the first pressure point 105. For example, a force 405 can be applied to the first roller 110 by a first actuator. The force 405 can act in a direction that is substantially perpendicular to the seventh tangent line 335 such that the force 405 can apply a pressure to the seventh pressure point 325. For example, the force 405 can cause a distance between the first roller 110 and the eighth roller 315 to decrease. The force 405 can cause the first roller 110 to apply a pressure (e.g., compress, manipulate) a battery active material 155 at the seventh pressure point 325. A force 410 can be applied to the first roller 110 in a direction that is substantially perpendicular to the first tangent line 120 such that the force 410 can be applied to the first pressure point 105. For example, the force 410 can cause the distance 225 between the first roller 110 and the second roller 115 to decrease. The force 410 can cause the first roller 110 to apply a pressure to (e.g., compress, manipulate) a battery active material 155 at the first pressure point 105.

The second roller 115 can be a transfer roller. For example, the second roller 115 can act to transfer the battery active material 155 from the first pressure point 105 to the second pressure point 125. The second roller 115 can transfer the battery active material 155 without any force being applied to the second roller 115 such that the second roller 115 remains static (e.g., rotates from a fixed point) as at least one force (e.g., the force 410) is applied to adjacent rollers. For example, the force 410 applied to the first roller 110 can be applied to the second roller 115 without being met with an opposing force applied to the second roller 115 by an actuator. For example, the force 410 applied to the first roller 110 can cause the distance 225 between the first roller 110 and the second roller 115 to decrease. The second roller 115 can facilitate the shearing or compression of the battery active material 155 at the first pressure point 105 by rotating in a static position. The second roller 115 can transfer the battery active material 155 from the first pressure point 105 to the second pressure point 125 without applying any force to compress or otherwise modify the battery active material 155.

The third roller 130 can be coupled with at least one actuator (e.g., a pneumatic actuator, a hydraulic actuator, a linear actuator, a rotation actuator, or other actuator) that can apply a constant or dynamic pressure to the third pressure point 140. For example, a third force 415 can be applied to the third roller 130 by an actuator. The third force 415 can act in a direction that is substantially perpendicular to the third tangent line 192 such that the force 415 can apply a pressure to the third pressure point 140. For example, the third force 415 can cause a distance between the third roller 130 and the fourth roller 145 to decrease. The third force 415 can apply a pressure to the battery active material 155 and the current collector material 194 to laminate the battery active material 155 with the current collector material 194, for example.

The ninth roller 345 can be coupled with an actuator that can apply a ninth force 420 at eighth pressure point 340 to compress the second battery active material 190 between the ninth roller 345 and the tenth roller 350 at the eighth pressure point 340. The force 420 applied by the actuator at the eighth pressure point 340 can cause the ninth roller 345 to move towards the tenth roller 350 at the eighth pressure point 340 in a direction perpendicular to the eighth tangent line 355 (e.g., cause the distance between the ninth roller 345 and the tenth roller 350 to decrease slightly). The tenth roller 350 can be a transfer roller. For example, no actuator can apply a force to the tenth roller 350 such that the tenth roller 350 remains static (e.g., rotate from a fixed point) as at least one force (e.g., the ninth force 420) is applied to adjacent rollers. The tenth roller 350 can transfer the second battery active material 190 from the eighth pressure point 340 to the ninth pressure point 360. The tenth roller 350 can facilitate the shearing or compression of the second battery active material 190 at the eighth pressure point 340 by rotating in a static position. The tenth roller 350 can transfer the second battery active material 190 from the eighth pressure point 340 to the ninth pressure point 360 without applying any force to compress or otherwise modify the second battery active material 190.

The fifth roller 165 can be coupled with at least one actuator (e.g., a pneumatic actuator, a hydraulic actuator, a linear actuator, a rotation actuator, or other actuator) that can apply a constant or dynamic pressure to the fourth pressure point 160 or to the ninth pressure point 360. For example, a force 425 can be applied to the fifth roller 165 by a first actuator. The force 425 can act in a direction that is substantially perpendicular to the ninth tangent line 365 such that the force 425 can apply a pressure to the ninth pressure point 360. For example, the force 425 can cause a distance between the fifth roller 165 and the tenth roller 350 to decrease. The force 405 can cause the fifth roller 165 to apply a pressure (e.g., compress, manipulate) the second battery active material 190 at the ninth pressure point 360. A force 430 can be applied to the fifth roller 165 in a direction that is substantially perpendicular to the fourth tangent line 175 such that the force 430 can be applied to the fourth pressure point 160. For example, the force 430 can cause a distance between the fifth roller 165 and the sixth roller 170 to decrease. The force 430 can cause the fifth roller 165 to apply a pressure to (e.g., compress, manipulate) a second battery active material 190 at the fourth pressure point 160.

The sixth roller 170 can be a transfer roller. For example, no actuator can apply a force to the sixth roller 170 such that the sixth roller 170 rotate within a static position as at least one force (e.g., the force 430) is applied to adjacent rollers. For example, the force 430 applied to the fifth roller 165 can be applied to the sixth roller 170 without met with an opposing force applied to the sixth roller 170 by an actuator. The force 430 applied to the fifth roller 165 can cause a distance between the fifth roller 165 and the sixth roller 170 to decrease. The sixth roller 170 can facilitate the shearing or compression of the second battery active material 190 at the fourth pressure point 160 by rotating in a static position. The sixth roller 170 can transfer the second battery active material 190 from the fourth pressure point 160 to the fifth pressure point 185 without applying any force to compress or otherwise modify the second battery active material 190.

The fourth roller 145 can be coupled with at least one actuator (e.g., a pneumatic actuator, a hydraulic actuator, a linear actuator, a rotation actuator, or other actuator) that can apply a constant or dynamic pressure to the third pressure point 140. For example, a force 435 can be applied to the fourth roller 145 by an actuator. The force 435 can act in a direction that is substantially perpendicular to the third tangent line 192 such that the force 435 can apply a pressure to the third pressure point 140. For example, the force 435 can cause a distance between the fourth roller 145 and the third roller 130 to decrease. The force 435 can apply a pressure to the second battery active material 190 and the current collector material 194 to laminate the second battery active material 190 with the current collector material 194, for example.

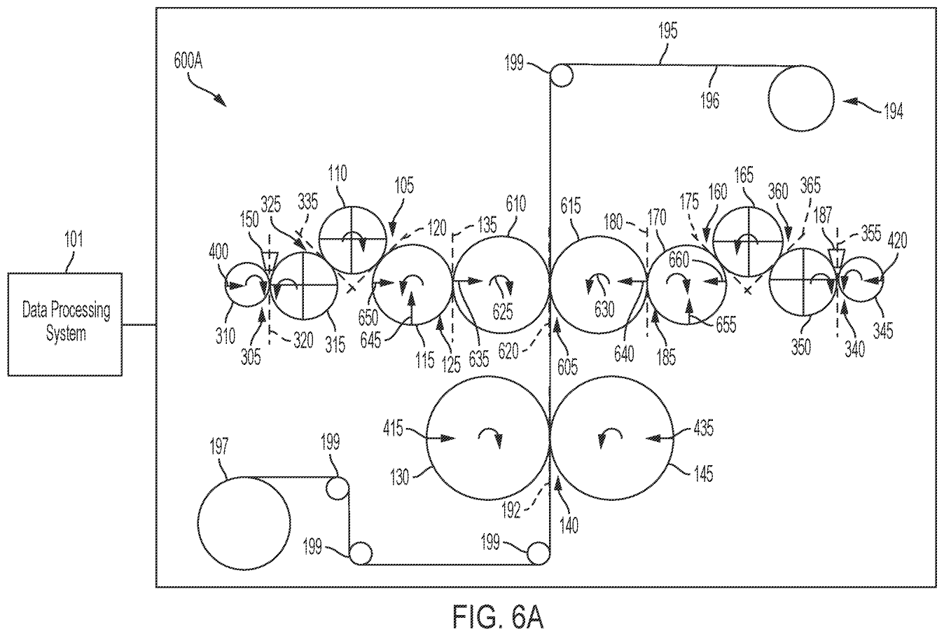

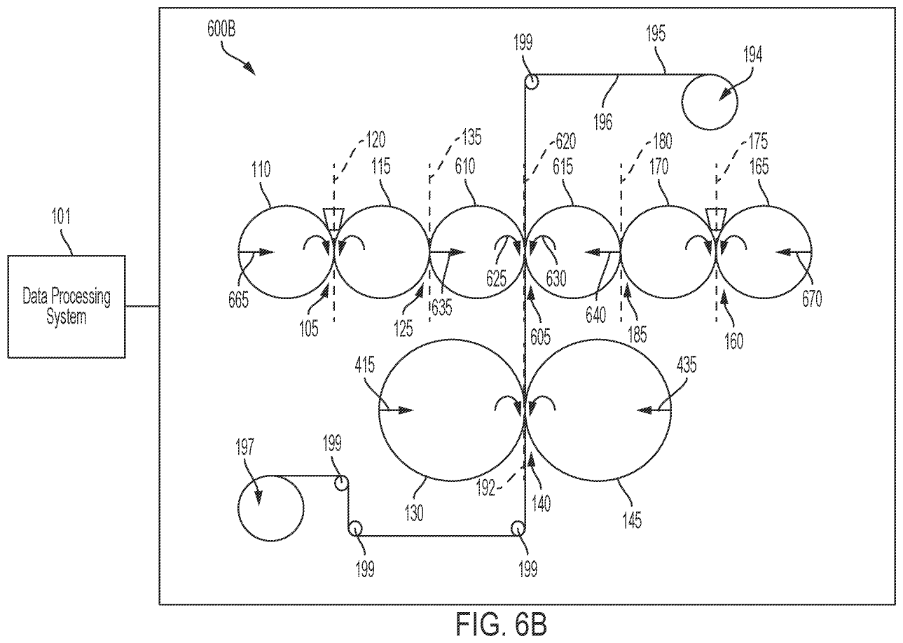

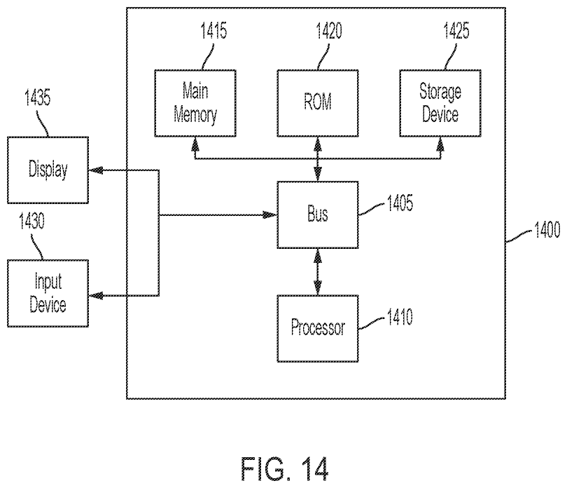

The system 100, the system 300, or other systems (e.g., the systems 600A and 600B shown in FIGS. 6A and 6B, among others) can include at least one actuator or other actuating device that can apply a force or pressure to at least one roller. For example, an actuator can cause one roller to move relative to an adjacent roller to apply a compression force (e.g., pressure) between two adjacent rollers. The compression force can cause or facilitate the compression, shearing, lamination, manipulation, or modification of a battery active material (e.g., battery active material 155 or second battery active material 190), film, or other substance passing between two adjacent rollers (e.g., through a pressure point). The system 100, the system 300, or other systems (e.g., the systems 600A and 600B shown in FIGS. 6A and 6B, among others) can include at least one roller that is not acted upon by an actuator. For example, the roller can be a transfer roller that can transfer the battery active material 155 or second battery active material 190 from one pressure point to another without applying any forces to compress or otherwise manipulate the respective battery active material 155, 190. The system 100, the system 300, or other systems (e.g., the systems 600A and 600B shown in FIGS. 6A and 6B, among others) can include at least one transfer roller and at least one roller that is actuated by an actuator. The actuators can be controlled by the data processing system 101 or the computer system 1400 shown in FIG. 14.

FIGS. 6A and 6B, among others, depict example systems 600A and 600B to manufacture an electrode. The systems 600A and 600B can produce an electrode for a battery. For example, the systems 600A and 600B can produce an electrode for a rechargeable battery of an electric vehicle, such as an electric truck or electric sport utility vehicle (SUV). Among other examples, the systems 600A and 600B can produce electrodes for a lithium ion (Li-ion) battery. The system 100 can produce a cathode electrode or an anode electrode that, when used in a battery, can receive electrical current or release electrons. For example, the systems 600A and 600B can receive a dry powdered material as an input and can produce an electrode including at least one battery active layer joined with (e.g., laminated with) a current collector material. The systems 600A and 600B can produce an electrode including a first film joined with a first side of a current collector material and a second film joined with a second side of the current collector material.

For example, the system 600A can include the first roller 110, the second roller 115, the third roller 130, the fourth roller 145, the fifth roller 165, the sixth roller 170, the seventh roller 310, the eighth roller 315, the ninth roller 345, and the tenth roller 350 as described herein with reference to FIGS. 1-5, among others. The system 600A can also include the first pressure point 105, the first tangent line 120, the second pressure point 125, the second tangent line 135, the third pressure point 140, the third tangent line 192, the fourth pressure point 160, the fourth tangent line 175, the fifth pressure point 185, the fifth tangent line 180, the sixth pressure point 305, the sixth tangent line 320, the seventh pressure point 325, the seventh tangent line 335, the eighth pressure point 340, the eighth tangent line 355, the ninth pressure point 360, and the ninth tangent line 365 as described above with reference to FIGS. 1-5, among others. The system 600A can also include the current collector material 194. The system 600A can produce the battery electrode 197.

The system 600A can include an eleventh roller 610 and a twelfth roller 615 that define a tenth tangent line 620. The eleventh roller 610 and the twelfth roller 615 can define a tenth pressure point 605 between the eleventh roller 610 and the twelfth roller 615. For example, the tenth pressure point 605 can be a gap (e.g., a space, a nip, an opening) between the eleventh roller 610 and the twelfth roller 615 where an outer surface of the eleventh roller 610 and an outer surface of the twelfth roller 615 are closest (e.g., where a distance between an outer surface of the eleventh roller 610 and an outer surface of the twelfth roller 615 is smallest). The eleventh roller 610 can rotate in an eleventh direction 625. The twelfth roller 615 can rotate in a twelfth direction 630.

An eleventh force 635 can be exerted on the eleventh roller 610 towards the tenth pressure point 605. A twelfth force 640 can be exerted on the twelfth roller 615 towards the tenth pressure point 605. For example, the eleventh force 635 and the twelfth force 640 can be respectively exerted on the eleventh roller 610 and the twelfth roller to compress or apply a pressure to the material passing through the tenth pressure point 605. The eleventh force 635 and the twelfth force 640 can facilitate the compression or lamination of the film formed at the second pressure point 125, the current collector material 194, and the film formed at the fifth pressure point 185, for example. The current collector material 194 can be laminated with the film formed at the second pressure point 125 and the film formed at the fifth pressure point 185. The tenth pressure point 605 can perform a calendaring operation (e.g., a compression operation) and a lamination operation that joins the film formed at the second pressure point 125 and the film formed at the fifth pressure point 185 with the current collector material 194.

The second pressure point 125 can be defined by the second roller 115 and the eleventh roller 610. For example, rather than being defined by the second roller 115 and the third roller 130 as shown in FIGS. 1-5, the second roller 115 and the eleventh roller 610 can define the second pressure point 125. The second pressure point 125 can be a gap (e.g., a space, a nip, an opening) between the second roller 115 and the eleventh roller 610 where an outer surface of the second roller 115 and an outer surface of eleventh roller 610 are closest (e.g., where a distance between an outer surface of the second roller 115 and an outer surface of the eleventh roller 610 is smallest).

Force 645 and 650 can be exerted on the second roller 115. For example, at least one actuator (e.g., a pneumatic cylinder, hydraulic cylinder, or linear or rotating actuator) can exert the force 645 on the second roller 115 in a substantially vertical direction (e.g., ±30 degrees from vertical). The force 645 can cause the second roller 115 to apply pressure at the first pressure point 105. For example, the force 645 can compress a material (e.g., a film of battery active material) passing through the first pressure point 105. At least one actuator (e.g., a pneumatic cylinder, hydraulic cylinder, or linear or rotating actuator) can exert the force 650 on the second roller 115 in a substantially horizontal direction (e.g., ±30 degrees from horizontal). The force 650 can cause the second roller 115 to apply pressure at the second pressure point 125. For example, the force 650 can compress a material (e.g., a film of battery active material) passing through the second pressure point 125.

The fifth pressure point 185 can be defined by the sixth roller 170 and the twelfth roller 615. For example, rather than being defined by the sixth roller 170 and the fourth roller 145 as shown in FIGS. 1-5, among others, the sixth roller 170 and the twelfth roller 615 can define the fifth pressure point 185. The fifth pressure point 185 can be a gap (e.g., a space, a nip, an opening) between the sixth roller 170 and the twelfth roller 615 where an outer surface of the sixth roller 170 and an outer surface of twelfth roller 615 are closest (e.g., where a distance between an outer surface of the sixth roller 170 and an outer surface of the twelfth roller 615 is smallest).

Forces 655 and 660 can be exerted on the sixth roller 170. For example, at least one actuator (e.g., a pneumatic cylinder, hydraulic cylinder, or linear or rotating actuator) can exert the force 655 on the sixth roller 170 in a substantially vertical direction (e.g., ±30 degrees from vertical). The force 655 can cause the sixth roller 170 to apply pressure at the fourth pressure point 160. For example, the force 655 can compress a material (e.g., a film of battery active material) passing through the fourth pressure point 160. At least one actuator (e.g., a pneumatic cylinder, hydraulic cylinder, or linear or rotating actuator) can exert the force 660 on the sixth roller 170 in a substantially horizontal direction (e.g., ±30 degrees from horizontal). The force 660 can cause the sixth roller 170 to apply pressure at the fifth pressure point 185. For example, the force 660 can compress a material (e.g., a film of battery active material) passing through the fifth pressure point 185.

The system 600B as depicted in FIG. 6B, among others, can include the first roller 110, the second roller 115, the third roller 130, the fourth roller 145, the fifth roller 165, the sixth roller 170, the eleventh roller 610 and the twelfth roller 615 as described herein with reference to FIGS. 1-6B, among others. The system 600B can also include the first pressure point 105, the first tangent line 120, the second pressure point 125, the second tangent line 135, the third pressure point 140, the third tangent line 192, the fourth pressure point 160, the fourth tangent line 175, the fifth pressure point 185, the fifth tangent line 180, the tenth pressure point 605, and the tenth tangent line 620 as described above with reference to FIGS. 1-6A, among others. The system 600B can also include the current collector material 194. The system 600B can produce the battery electrode 197.

The system 600A can include an eleventh roller 610 and a twelfth roller 615 that define a tenth tangent line 620. The eleventh roller 610 and the twelfth roller 615 can define a tenth pressure point 605 between the eleventh roller 610 and the twelfth roller 615. For example, the tenth pressure point 605 can be a gap (e.g., a space, a nip, an opening) between the eleventh roller 610 and the twelfth roller 615 where an outer surface of the eleventh roller 610 and an outer surface of the twelfth roller 615 are closest (e.g., where a distance between an outer surface of the eleventh roller 610 and an outer surface of the twelfth roller 615 is smallest). The eleventh roller 610 can rotate in an eleventh direction 625. The twelfth roller 615 can rotate in a twelfth direction 630.

A thirteenth force 665 can be exerted on the first roller 110 towards the first pressure point 105. A fourteenth force 670 can be exerted on the fifth roller 165 towards the fourth pressure point 160. The force 665 be applied to the first roller 110 in a direction that is substantially perpendicular to the first tangent line 120 such that the force 665 can be applied to the first pressure point 105. For example, the force 665 can cause the distance 225 between the first roller 110 and the second roller 115 to decrease. The force 665 can cause the first roller 110 to apply a pressure to (e.g., compress, manipulate) the battery active material 155 at the first pressure point 105. The force 670 can be applied to the fifth roller 165 in a direction that is substantially perpendicular to the fourth tangent line 175 such that the force 670 can be applied to the fourth pressure point 160. For example, the force 670 can cause a distance between the fifth roller 165 and the sixth roller 170 to decrease. The force 670 can cause the fifth roller 165 to apply a pressure to (e.g., compress, manipulate) the second battery active material 190 at the fifth pressure point 185.

The first roller 110, the second roller 115, the eleventh roller 610, the twelfth roller 615, the sixth roller 170, and the fifth roller 165 can be arranged in a coupled orientation. For example, the first tangent line 120, the second tangent line 135, the tenth tangent line 620, the fifth tangent line 180, and the fourth tangent line 175 can be substantially parallel (e.g., ±150 from parallel) with each other. None of the first pressure point 105, second pressure point 125, tenth pressure point 605, fifth pressure point 185, and the fourth pressure point 160 can be decoupled. Rather, each of the first pressure point 105, second pressure point 125, tenth pressure point 605, fifth pressure point 185, and the fourth pressure point 160 can be arranged in a coupled orientation. However, the third pressure point 140 can be decoupled from the first pressure point 105, second pressure point 125, tenth pressure point 605, fifth pressure point 185, and the fourth pressure point 160.

As shown in FIGS. 6A and 6B, among others, the current collector material 194 can pass through the tenth pressure point 605 along with a film formed in at the second pressure point 125 (e.g., between the second roller 115 and the eleventh roller) and a film formed at the fifth pressure point 185 (e.g., between the sixth roller 170 and the twelfth roller 615). The systems 600A and 600B can laminate the current collector material 194 with the film formed at the second pressure point 125 or with the film formed at the fifth pressure point 185 via the tenth pressure point 605. The systems 600A and 600B can compress the film formed at the second pressure point 125, the current collector material 194, and the film formed at the fifth pressure point 185 via the tenth pressure point 605. For example, the eleventh force 635 and the twelfth force 640 can compress the film formed at the second pressure point 125, the current collector material 194, and the film formed at the fifth pressure point 185. The systems 600A and 600B can perform a calendaring operation at the tenth pressure point 605 to control a density or thickness of the one or more of the film formed at the second pressure point 125, the current collector material 194, and the film formed at the fifth pressure point 185.

The systems 600A and 600B can include the third pressure point 140 separated from the tenth pressure point 605. For example, the third pressure point 140 can be spaced apart from the tenth pressure point 605 such that the third roller 130 is not adjacent to and does not form a pressure point with either of the eleventh roller 610 or the twelfth roller 615. The third pressure point 140 can be spaced apart from the tenth pressure point 605 such that the fourth roller 145 is not adjacent to and does not form a pressure point with either of the eleventh roller 610 or the twelfth roller 615 For example, the systems 600A and 600B can laminate the film formed at the second pressure point 125, the current collector material 194, and the film formed at the fifth pressure point 185 at the tenth pressure point 605 and compress or calendar the film formed at the second pressure point 125 and the film formed at the fifth pressure point 185 with the current collector material 194 at the third pressure point 140 that is spaced apart from the tenth pressure point 605. The systems 600A and 600B can include the third pressure point 140 to calendar the film formed at the second pressure point 125, the current collector material 194, and the film formed at the fifth pressure point 185. For example, the film formed at the second pressure point 125 and the film formed at the fifth pressure point 185 can be laminated with the current collector material 194 at the tenth pressure point 605. The third pressure point 140 therefore need not perform a lamination operation and can instead perform only a calendaring operation to compress the film formed at the second pressure point 125, the current collector material 194, and the film formed at the fifth pressure point 185. As noted above, a calendaring operation can also be performed at the tenth pressure point 605. In such examples, the calendaring operation at the third pressure point 140 can be a second calendaring operation. For example, the calendaring operation performed at the third pressure point 140 can include compressing the film formed at the second pressure point 125, the current collector material 194, and the film formed at the fifth pressure point 185 at a higher pressure than a calendaring operation performed at the tenth pressure point 605.

Because the third pressure point 140 is spaced apart from the tenth pressure point 605, any forces exerted at the tenth pressure point 605 can be isolated from forces exerted at the third pressure point 140. For example, the tenth pressure point 605 can define the tenth tangent line 620 that extends in a substantially vertical direction (e.g., ±30 degrees from vertical) and the third pressure point 140 can define a third tangent line 192 that is also substantially vertical (e.g., ±30 degrees from vertical). Even though the tenth tangent line 620 and the third tangent line 192 are parallel, forces exerted at the tenth pressure point 605 can be separated from (e.g., isolated from) the third pressure point 140, just as the forces exerted at the third pressure point 140 (e.g., third force 415 and fourth force 435) can be separated from the tenth pressure point 605. Pressure point 140 can be located further downstream or in some other location relative to the pressure point 605 rather than being in-line with the pressure point 605.

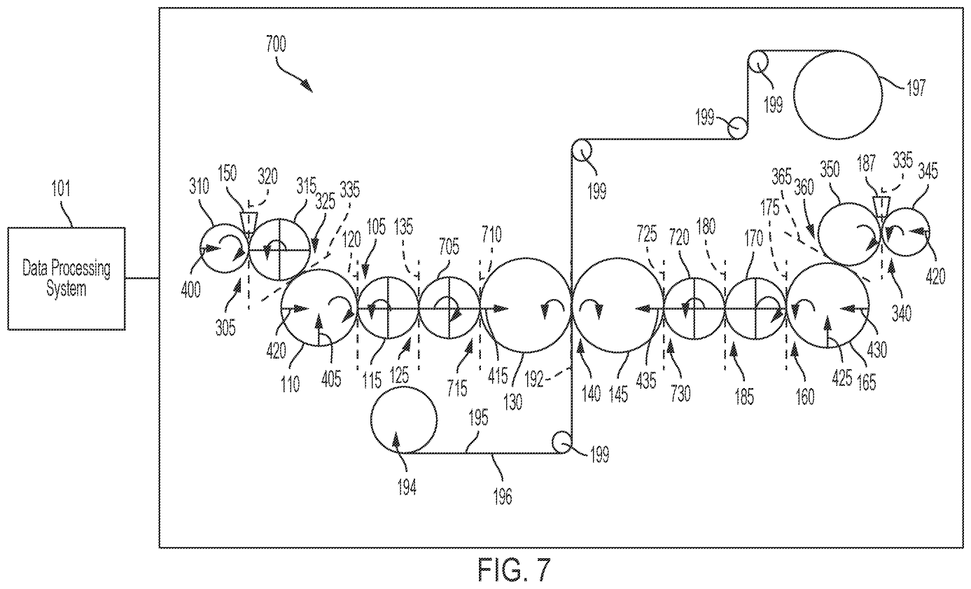

FIG. 7, among others, depicts a system 700 for manufacturing a battery electrode. The system 700 can include the first roller 110, the second roller 115, the third roller 130, the fourth roller 145, the fifth roller 165, the sixth roller 170, the seventh roller 310, the eighth roller 315, the ninth roller 345 and the tenth roller 350 as described above with reference to FIGS. 1-6B, among others. The system 700 can include the first pressure point 105, the first tangent line 120, the third pressure point 140, the third tangent line 192, the fourth pressure point 160, the fourth tangent line 175, the sixth pressure point 305, the sixth tangent line 320, the seventh pressure point 325, the seventh tangent line 335, the eighth pressure point 340, the eighth tangent line 355, the ninth pressure point 360, and the ninth tangent line 365 as described above with reference to FIGS. 1-6B, among others.

The system 700 can include a thirteenth roller 705. The thirteenth roller 705 can have a thirteenth roller diameter. For example, the thirteenth roller diameter can be different than the second roller diameter or the third roller diameter. The thirteenth roller diameter can be the same as or substantially similar to (e.g., ±15%) the second roller diameter, the third roller diameter, or some other roller diameter (e.g., the first roller diameter). The thirteenth roller 705 can rotate about a thirteenth axis in a thirteenth direction. The thirteenth axis can be parallel with the second axis and the third axis, for example. The thirteenth direction can be opposite the second direction 116 and the third direction 131. The thirteenth roller 705 can rotate about the thirteenth axis at a thirteenth circumferential speed to achieve a thirteenth angular velocity. For example, the thirteenth circumferential speed can be different than the second circumferential speed and the third circumferential speed. The thirteenth circumferential speed can be 1.5 to two times or more than two times greater than the second circumferential speed. The thirteenth circumferential speed can be the same as or substantially similar to (e.g., ±15%) the third circumferential speed or the second circumferential speed. The thirteenth angular velocity can be different than the third angular velocity. For example, the third angular velocity can be 1.5 to two times or more than two times greater than the thirteenth angular velocity. In other examples, the thirteenth angular velocity can be the same as or substantially similar to (e.g., ±15%) the third angular velocity, the second angular velocity, or some other angular velocity.

The second pressure point 125 can be defined by the second roller 115 and the thirteenth roller 705. For example, rather than being defined by the second roller 115 and the third roller 130 as shown in FIGS. 1-5, the second roller 115 and the thirteenth roller 705 can define the second pressure point 125. The second pressure point 125 can be a gap (e.g., a space, a nip, an opening) between the second roller 115 and the eleventh roller 610 where an outer surface of the second roller 115 and an outer surface of eleventh roller 610 are closest (e.g., where a distance between an outer surface of the second roller 115 and an outer surface of the eleventh roller 610 is smallest).

The system 700 can include the third roller 130 and the thirteenth roller 705 to define a thirteenth tangent line 710. The third roller 130 and the thirteenth roller 705 can define an eleventh pressure point 715 between the third roller 130 and the thirteenth roller 705. For example, the eleventh pressure point 715 can be a gap (e.g., a space, a nip, an opening) between the third roller 130 and the thirteenth roller 705 where an outer surface of the third roller 130 and an outer surface of the thirteenth roller 705 are closest (e.g., where a distance between an outer surface of the third roller 130 and an outer surface of the thirteenth roller 705 is smallest).

The thirteenth roller 705 can rotate in the thirteenth direction that is opposite the third direction 131. For example, the third speed of the third roller 130 can be different than (e.g., greater than) the thirteenth speed of the thirteenth roller 705. The third circumferential speed can be greater than or less than the thirteenth circumferential speed. The third circumferential speed can be the same as or substantially similar to (e.g., ±15%) to the thirteenth circumferential speed. The third angular velocity of the third roller 130 can be different than the thirteenth angular velocity of the thirteenth roller 705. The third angular velocity of the third roller 130 can be greater than the thirteenth angular velocity of the thirteenth roller 705. The third angular velocity can be the same as or substantially similar to (e.g., ±15%) the thirteenth angular velocity.

The thirteenth roller 705 can be a transfer roller. For example, no actuator can apply a force to the thirteenth roller 705 such that the thirteenth roller 705 acts to transfer the battery active material 155 from the second pressure point 125 to the eleventh pressure point 715. The thirteenth roller 705 can remain static as forces are applied to adjacent or nearby rollers (e.g., force 420 applied to the first roller 110). The second roller 115 can also be a transfer roller. For example, no actuator can apply a force to the second roller 115 such that the second roller 115 acts to transfer the battery active material 155 from the first pressure point 105 to the second pressure point 125 between the second roller 115 and the thirteenth roller 705. The second roller 115 can remain static as forces (e.g., the force 420) are applied to adjacent rollers (e.g., the first roller 110).

The system 700 can include a fourteenth roller 720. The fourteenth roller 720 can have a fourteenth roller diameter. For example, the fourteenth roller diameter can be different than the sixth roller diameter or the fourth roller diameter. The fourteenth roller diameter can be the same as or substantially similar to (e.g., ±15%) the fourth roller diameter or some other roller diameter (e.g., the third roller diameter, the sixth roller diameter). The fourteenth roller 720 can rotate about a fourteenth axis in a fourteenth direction. The fourteenth axis can be parallel with the sixth axis and the fourth axis, for example. The fourteenth direction can be opposite the sixth direction 176 and the fourth direction 146. The fourteenth roller 720 can rotate about the fourteenth axis at a fourteenth circumferential speed to achieve a fourteenth angular velocity. For example, the fourteenth circumferential speed can be different than the sixth circumferential speed and the fourth circumferential speed. The fourteenth circumferential speed can be 1.5 to two times or more than two times greater than the sixth circumferential speed. The fourteenth circumferential speed can be the same as or substantially similar to (e.g., ±15%) the sixth circumferential speed, the fourth circumferential speed, or some other circumferential speed (e.g., the fifth circumferential speed). The fourteenth angular velocity can be different than the fourth angular velocity. For example, the fourth angular velocity can be 1.5 to two times or more than two times greater than the fourteenth angular velocity. In other examples, the fourteenth angular velocity can be the same as or substantially similar to (e.g., ±15%) the fourth angular velocity.

The fifth pressure point 185 can be defined by the sixth roller 170 and the fourteenth roller 720. For example, rather than being defined by the sixth roller 170 and the fourth roller 145 as shown in FIGS. 1-5, among others, the sixth roller 170 and the fourteenth roller 720 can define the fifth pressure point 185. The fifth pressure point 185 can be a gap (e.g., a space, a nip, an opening) between the sixth roller 170 and the fourteenth roller 720 where an outer surface of the sixth roller 170 and an outer surface of fourteenth roller 720 are closest (e.g., where a distance between an outer surface of the sixth roller 170 and an outer surface of the fourteenth roller 720 is smallest).

The system 700 can include the fourth roller 145 and the fourteenth roller 720 to define a twelfth tangent line 725. The fourth roller 145 and the fourteenth roller 720 can define a twelfth pressure point 730 between the fourth roller 145 and the fourteenth roller 720. For example, the twelfth pressure point 730 can be a gap (e.g., a space, a nip, an opening) between the fourth roller 145 and the fourteenth roller 720 where an outer surface of the fourth roller 145 and an outer surface of the fourteenth roller 720 are closest (e.g., where a distance between an outer surface of the fourth roller 145 and an outer surface of the fourteenth roller 720 is smallest).

The fourteenth roller 720 can rotate in the fourteenth direction that is opposite the fourth direction 146. For example, the fourth speed of the fourth roller 145 can be different than (e.g., greater than) the fourteenth speed of the fourteenth roller 720. The fourth angular velocity of the fourth roller 145 can be different than the fourteenth angular velocity of the fourteenth roller 720. The fourth angular velocity of the fourth roller 145 can be greater than the fourteenth angular velocity of the fourteenth roller 720. The fourth angular velocity can be the same as or substantially similar to (e.g., ±15%) the fourteenth angular velocity or some other angular velocity (e.g., the sixth angular velocity).

The fourteenth roller 720 can be a transfer roller. For example, no actuator can apply a force to the fourteenth roller 720 such that the fourteenth roller 720 acts to transfer the second battery active material 190 from the fifth pressure point 185 to the twelfth pressure point 730. The fourteenth roller 720 can remain static as forces are applied to adjacent or nearby rollers (e.g., force 430 applied to the fourth roller 145). The sixth roller 170 can also be a transfer roller. For example, no actuator can apply a force to the sixth roller 170 such that the sixth roller 170 acts to transfer the second battery active material 190 from the fourth pressure point 160 to the fifth pressure point 185 between the sixth roller 170 and the fourteenth roller 720. The sixth roller 170 can remain static as forces (e.g., the force 430) are applied to adjacent rollers (e.g., the fifth roller 165).

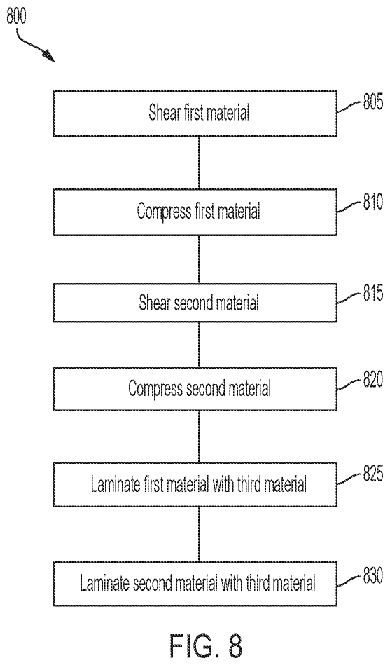

FIG. 8 depicts a flowchart of a method 800 of manufacturing a battery electrode with the system 100, the system 300, the systems 600A and 600B, and the system 700, for example. The method can include one or more of ACTS 805-830. The method 800 can be performed by the above-described components of the system 100, the above-described components of the system 300, the above-described components of systems 600A and 600B, the above-described components of system 700, or some other components of some other system, for example.

The method 800 can include can include applying a force (e.g., a shearing force or a compressive force) to a first material at ACT 805. The method 800 can include activating the first roller 110 or the second roller 115 to apply force to the first battery active material 155. For example, the method 800 can include shearing or compressing the battery active material 155 with the first roller 110 and the second roller 115. The first roller 110 and the second roller 115 can define the first tangent line 120 and the first pressure point 105. The first infeed device 150 can provide the first battery active material 155 to the first pressure point 105, a surface of the first roller 110, or a surface of the second roller 115. The battery active material 155 can be sheared or compressed through the first pressure point 105 along the first tangent line 120. For example, the first roller 110 and the second roller 115 can rotate inwards towards the first pressure point 105 to pull or draw the battery active material 155 into and through the first pressure point 105 between the first roller 110 and the second roller 115. As the battery active material 155 is drawn through the first pressure point 105, it can be compressed or sheared to form a first film. For example, the first roller 110 can rotate in the first direction 111 at a first speed and first angular velocity, while the second roller 115 can contra-rotate in the second direction 116 at a second speed and second angular velocity, where the first speed or first angular velocity can be less than the second speed or second angular velocity, respectively. A difference in speed or angular velocity of the first roller 110 and the second roller 115 can create a shearing force that shears the battery active material 155 as it passes through the first pressure point 105.

The method 800 can include applying a force (e.g., a shearing force or a compressive force) to the first material at ACT 810. For example, the method 800 can include compressing or shearing the first film comprising the battery active material 155 (e.g., the first film produced at ACT 805) with the second roller 115 and the third roller 130. The second roller 115 and the third roller 130 can define the second tangent line 135 and the second pressure point 125, where the second tangent line 135 can intersect the first tangent line 120 such that the second pressure point 125 and the first pressure point 105 are decoupled. The first film can be compressed or sheared through the second pressure point 125 along the second tangent line 135. For example, the second roller 115 and the third roller 130 can rotate inwards towards the second pressure point 125 to pull or draw the first film into and through the second pressure point 125 between the second roller 115 and the third roller 130. As the first film is drawn through the second pressure point 125, it can be compressed or sheared to form a second film. For example, the second roller 115 can rotate in the second direction 116 at a second speed and second angular velocity, while the third roller 130 can contra-rotate in the third direction 131 at a third speed and third angular velocity, where the second speed or second angular velocity can be different than the third speed or third angular velocity, respectively. A difference in speed or angular velocity of the second roller 115 and the third roller 130 can create a shearing force that compresses the first film as it passes through the second pressure point 125.

The method 800 can include applying a force (e.g., a shearing force or a compressive force) to a second material at ACT 815. ACT 815 can be optional. ACT 815 can occur substantially simultaneously with ACT 805. ACT 815 can include activating the fifth roller 165 or the sixth roller 170 to apply force to the second battery active material 190. The ACT 815 can include shearing or compressing the second battery active material 190 with a fifth roller 165 and a sixth roller 170. The fifth roller 165 and the sixth roller 170 can define the fourth tangent line 175 and the fourth pressure point 160. The second infeed device 187 can provide the second battery active material 190 to the fourth pressure point 160, a surface of the fifth roller 165, or a surface of the sixth roller 170. The second battery active material 190 can be sheared or compressed through the fourth pressure point 160 along the fourth tangent line 175. For example, the fifth roller 165 and the sixth roller 170 can rotate inwards towards the fourth pressure point 160 to pull or draw the second battery active material 190 into and through the fourth pressure point 160 between the fifth roller 165 and the sixth roller 170. As the second battery active material 190 is drawn through the fourth pressure point 160, it can be compressed or sheared to form a third film. For example, the fifth roller 165 can rotate in the fifth direction 171 at a fifth speed and fifth angular velocity, while the sixth roller 170 can contra-rotate in the sixth direction 176 at a sixth speed and sixth angular velocity, where the fifth speed or fifth angular velocity can be less than the sixth speed or sixth angular velocity, respectively. A difference in speed or angular velocity of the fifth roller 165 and the sixth roller 170 can create a shearing force that shears the second battery active material 190 as it passes through the fourth pressure point 160.

The method 800 can include applying a force (e.g., a shearing force or a compressive force) to the second material at ACT 820. ACT 820 can be optional. ACT 820 can occur substantially simultaneously with ACT 810. The ACT 820 can include compressing or shearing the second battery active material 190 (e.g., the third film produced at ACT 815) with the fourth roller 145 and the sixth roller 170. The fourth roller 145 and the sixth roller 170 can define the fifth tangent line 180 and the fifth pressure point 185, where the fifth tangent line 180 can intersect the fourth tangent line 175 such that the fifth pressure point 185 and the fourth pressure point 160 are decoupled. The third film can be compressed or sheared through the fifth pressure point 185 along the fifth tangent line 180. For example, the fourth roller 145 and the sixth roller 170 can rotate inwards towards the fifth pressure point 185 to pull or draw the third film into and through the fifth pressure point 185 between the fourth roller 145 and the sixth roller 170. As the third film is drawn through the fifth pressure point 185, it can be compressed or sheared to form a fourth film. For example, the fourth roller 145 can rotate in the fourth direction 146 at a fourth speed and fourth angular velocity, while the sixth roller 170 can contra-rotate in the sixth direction 176 at a sixth speed and sixth angular velocity, where the fourth speed or fourth angular velocity can be different than the sixth speed or sixth angular velocity, respectively. A difference in speed or angular velocity of the fourth roller 145 and the sixth roller 170 can create a shearing force that compresses the third film as it passes through the fifth pressure point 185.

The method 800 can include laminating the first material at ACT 825. For example, ACT 825 can include laminating the second film comprising the battery active material 155 with the first side of the current collector material 194. The third roller 130 and the fourth roller 145 can receive the second film produced by ACT 810 and the current collector material 194, where the current collector material 194 can have a first side 195 and a second side 196. The third roller 130 and the fourth roller 145 can laminate the second film with the first side 195 of the current collector material 194. The third roller 130 and the fourth roller 145 can rotate inwards towards the third pressure point 140 to pull or draw the second film and the current collector material 194, into and through the third pressure point 140 between the third roller 130 and the fourth roller 145. For example, the second film can contact (e.g., abut, be adjacent to) the first side 195 of the current collector material 194 as the second film and the current collector material 194 enter the third pressure point 140. As the second film and the current collector material 194 are drawn through the third pressure point 140, the second film can be laminated with the first side 195 of the current collector material 194 to form an electrode material 197. When laminated, second film comprising the battery active material 155 and the current collector material 194 can be joined such that the second film cannot easily be separated from the first side 195 of the current collector material 194 (e.g., without use of substantial force). The third roller 130 or the fourth roller 145 can be heated (e.g., have a temperature of between 50-200° C.) to facilitate the lamination operation at the third pressure point 140.

The method 800 can include laminating the material at ACT 830. ACT 830 can be optional. ACT 830 can occur substantially simultaneously with ACT 825. The third roller 130 and the fourth roller 145 can receive the fourth film produced by ACT 820 and the current collector material 194. The third roller 130 and the fourth roller 145 can laminate the fourth film with the second side 196 of the current collector material 194. The third roller 130 and the fourth roller 145 can rotate inwards towards the third pressure point 140 to pull or draw the fourth film and the current collector material 194, into and through the third pressure point 140 between the third roller 130 and the fourth roller 145. For example, the fourth film can contact (e.g., abut, be adjacent to) the second side 196 of the current collector material 194 as the fourth film and the current collector material 194 enter the third pressure point 140. As the fourth film and the current collector material 194 are drawn through the third pressure point 140, the fourth film can be laminated with the second side 196 of the current collector material 194 to form an electrode material 197. When laminated, fourth film comprising the second battery active material 190 and the current collector material 194 can be joined such that the fourth film cannot easily be separated from the first side 195 of the current collector material 194 (e.g., without use of substantial force).

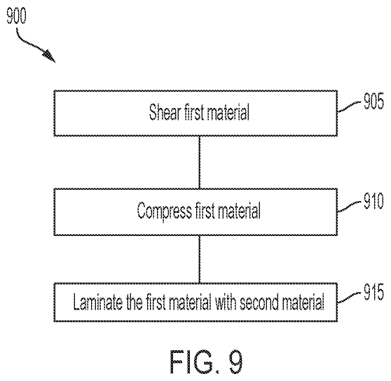

FIG. 9 depicts a method 900 of manufacturing a battery electrode comprising a first battery active material laminated with a current collector material is shown. The method can include one or more of ACTS 905-915. The method 900 can be performed by the above-described components of the system 100, the above-described components of the system 300, or some other components of some other system (e.g., systems 600A, 600B, or 700, among others).

The method 900 can include applying a force (e.g., a shearing force or a compressive force) to a first material at ACT 905. The method 900 can include activating the first roller 110 or the second roller 115 to apply force to the first battery active material 155. For example, the method 900 can include shearing or compressing the battery active material 155 with the first roller 110 and the second roller 115. The first roller 110 and the second roller 115 can define the first tangent line 120 and the first pressure point 105. The first infeed device 150 can provide the first battery active material 155 to the first roller 110 or second roller 115. The battery active material 155 can be sheared or compressed through the first pressure point 105 along the first tangent line 120. For example, the first roller 110 and the second roller 115 can rotate inwards towards the first pressure point 105 to pull or draw the battery active material 155 into and through the first pressure point 105 between the first roller 110 and the second roller 115. As the battery active material 155 is drawn through the first pressure point 105, it can be compressed or sheared to form a first film.

The method 900 can include applying a force (e.g., a shearing force or a compressive force) to the first material at ACT 910. For example, the method 900 can include compressing or shearing the first film comprising the battery active material 155 (e.g., the first film produced at ACT 905) with the second roller 115 and the third roller 130. The second roller 115 and the third roller 130 can define the second tangent line 135 and the second pressure point 125, where the second tangent line 135 can intersect the first tangent line 120 such that the second pressure point 125 and the first pressure point 105 are decoupled. The second tangent line 135 can be non-parallel with the first tangent line 120. The first film can be compressed or sheared through the second pressure point 125 along the second tangent line 135. For example, the second roller 115 and the third roller 130 can rotate inwards towards the second pressure point 125 to pull or draw the first film into and through the second pressure point 125 between the second roller 115 and the third roller 130. As the first film is drawn through the second pressure point 125, it can be compressed or sheared to form a second film.

The method 900 can include laminating the first material with a second material at ACT 915. For example, the second material can comprise the current collector material 194. ACT 915 can include laminating the second film comprising the battery active material 155 with the first side of the current collector material 194. The third roller 130 and the fourth roller 145 can receive the second film produced by ACT 910 and the current collector material 194, where the current collector material 194 can have a first side 195 and a second side 196. The third roller 130 and the fourth roller 145 can laminate the second film with the first side 195 of the current collector material 194. The third roller 130 and the fourth roller 145 can rotate inwards towards the third pressure point 140 to pull or draw the second film and the current collector material 194, into and through the third pressure point 140 between the third roller 130 and the fourth roller 145. For example, the second film can contact (e.g., abut, be adjacent to) the first side 195 of the current collector material 194 as the second film and the current collector material 194 enter the third pressure point 140. As the second film and the current collector material 194 are drawn through the third pressure point 140, the second film can be laminated with the first side 195 of the current collector material 194 to form an electrode material 197. When laminated, second film comprising the battery active material 155 and the current collector material 194 can be joined such that the second film cannot easily be separated from the first side 195 of the current collector material 194 (e.g., without use of substantial force).

The method 900 can also include laminating the second battery active material 190 with the second side 196 of the current collector material 194. For example, the third roller 130 and the fourth roller 145 can laminate a film comprising the second battery active material 190 with the second side 196 of the current collector material 194. The third roller 130 and the fourth roller 145 can rotate inwards towards the third pressure point 140 to pull or draw the film comprising the second battery active material 190 and the current collector material 194, into and through the third pressure point 140 between the third roller 130 and the fourth roller 145. For example, the film comprising the second battery active material 190 can contact (e.g., abut, be adjacent to) the second side 196 of the current collector material 194 as the film and the current collector material 194 enter the third pressure point 140. As the film comprising the second battery active material 190 and the current collector material 194 are drawn through the third pressure point 140, the film can be laminated with the second side 196 of the current collector material 194 to form an electrode material 197. When laminated, film comprising the second battery active material 190 and the current collector material 194 can be joined such that the film cannot easily be separated from the first side 195 of the current collector material 194 (e.g., without use of substantial force). For example, the second battery active material 190 can be laminated with the second side 196 of the current collector material 194 substantially simultaneously with the lamination of the second film with the first side of the current collector material 194 at ACT 915.

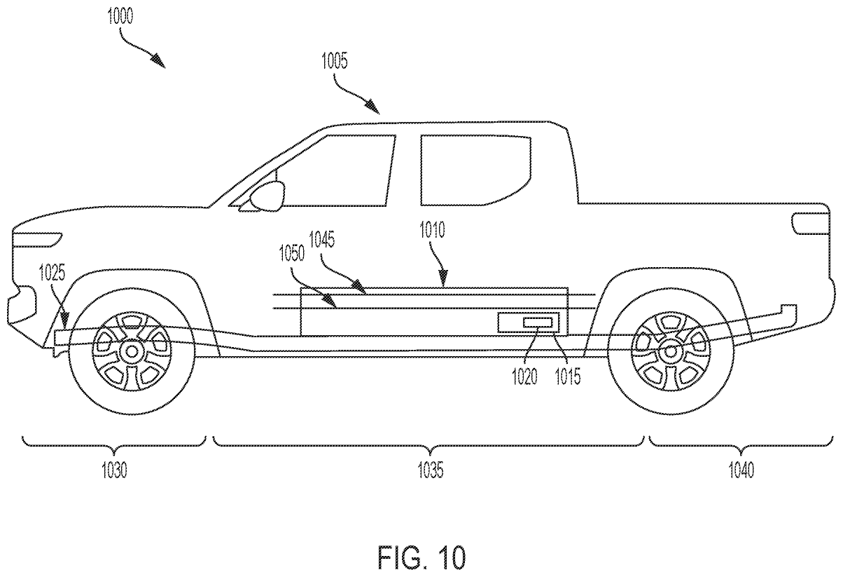

FIG. 10 depicts is an example cross-sectional view 1000 of an electric vehicle 1005 installed with at least one battery pack 1010. Electric vehicles 1005 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 1010 can also be used as an energy storage system to power a building, such as a residential home or commercial building. Electric vehicles 1005 can be fully electric or partially electric (e.g., plug-in hybrid) and further, electric vehicles 1005 can be fully autonomous, partially autonomous, or unmanned. Electric vehicles 1005 can also be human operated or non-autonomous. Electric vehicles 1005 such as electric trucks or automobiles can include on-board battery packs 1010, battery modules 1015, or battery cells 1020 to power the electric vehicles. For example, the battery cells 1020 can include at least one battery electrode manufactured using the system 100 of FIGS. 1 and 2, the system 300 of FIGS. 3-5, the systems 600A and 600B of FIGS. 6A and 6B, the system 700 of FIG. 7, the method 800 of FIG. 8, or the method 900 of FIG. 9.

The electric vehicle 1005 can include a chassis 1025 (e.g., a frame, internal frame, or support structure). The chassis 1025 can support various components of the electric vehicle 1005. The chassis 1025 can span a front portion 1030 (e.g., a hood or bonnet portion), a body portion 1035, and a rear portion 1040 (e.g., a trunk, payload, or boot portion) of the electric vehicle 1005. The battery pack 1010 can be installed or placed within the electric vehicle 1005. For example, the battery pack 1010 can be installed on the chassis 1025 of the electric vehicle 1005 within one or more of the front portion 1030, the body portion 1035, or the rear portion 1040. The battery pack 1010 can include or connect with at least one busbar, e.g., a current collector element. For example, the first busbar 1045 and the second busbar 1050 can include electrically conductive material to connect or otherwise electrically couple the battery modules 1015 or the battery cells 1020 with other electrical components of the electric vehicle 1005 to provide electrical power to various systems or components of the electric vehicle 1005.

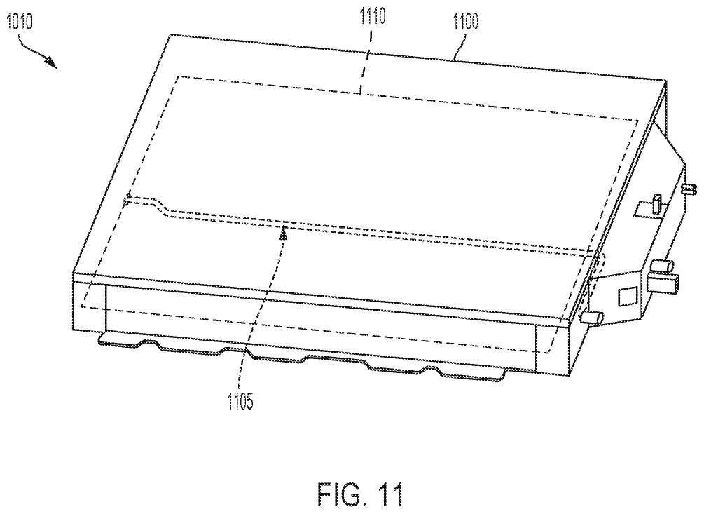

FIG. 11 depicts an example battery pack 1010. Referring to FIG. 11, among others, the battery pack 1010 can provide power to electric vehicle 1005. Battery packs 1010 can include any arrangement or network of electrical, electronic, mechanical or electromechanical devices to power a vehicle of any type, such as the electric vehicle 1005. The battery pack 1010 can include at least one housing 1100. The housing 1100 can include at least one battery module 1015 or at least one battery cell 1020, as well as other battery pack components. The battery module 1015 can be or can include one or more groups of prismatic cells, cylindrical cells, pouch cells, or other form factors of battery cells 1020. The housing 1100 can include a shield on the bottom or underneath the battery module 1015 to protect the battery module 1015 or battery cells 1020 from external conditions, for example if the electric vehicle 1005 is driven over rough terrains (e.g., off-road, trenches, rocks, etc.) The battery pack 1010 can include at least one cooling line 1105 that can distribute fluid through the battery pack 1010 as part of a thermal/temperature control or heat exchange system that can also include at least one thermal element (e.g., cold plate 1110. The cold plate 1110 can be positioned in relation to a top submodule and a bottom submodule, such as in between the top and bottom submodules, among other possibilities. The battery pack 1010 can include any number of cold plates 1110. For example, there can be one or more cold plates 1110 per battery pack 1010, or per battery module 1015. At least one cooling line 1105 can be coupled with, part of, or independent from the cold plate 1110.

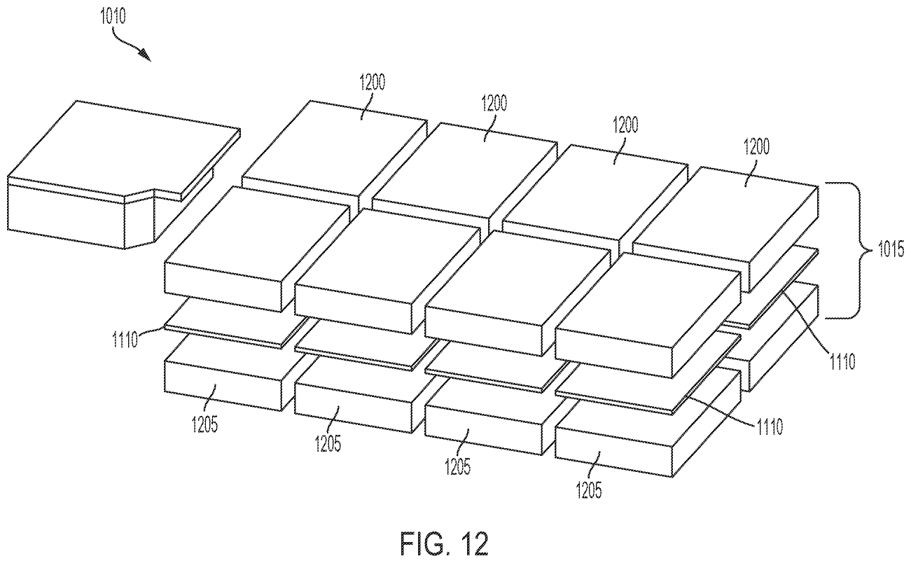

FIG. 12 depicts example battery modules 1015, and FIG. 13 depicts an example cross sectional view of a battery cell 1020. The battery modules 1015 can include at least one submodule. For example, the battery modules 1015 can include at least one top submodule 1200 or at least one bottom submodule 1205. At least one cold plate 1110 can be disposed between the top submodule 1200 and the bottom submodule 1205. For example, one cold plate 1110 can be configured for heat exchange with one battery module 1015. The cold plate 1110 can be disposed or thermally coupled between the top submodule 1200 and the bottom submodule 1205. One cold plate 1110 can also be thermally coupled with more than one battery module 1015 (or more than two submodules 1200, 1205). The battery submodules 1200, 1205 can collectively form one battery module 1015. For example, each submodule 1200, 1205 can be considered as a complete battery module 1015, rather than a submodule.

The battery modules 1015 can each include a plurality of battery cells 1020. The battery modules 1015 can be disposed within the housing 1100 of the battery pack 1010. The battery modules 1015 can include battery cells 1020 that are cylindrical cells, pouch cells, or prismatic cells, for example. The battery module 1015 can operate as a modular unit of battery cells 1020. For example, a battery module 1015 can collect current or electrical power from the battery cells 1020 that are included in the battery module 1015 and can provide the current or electrical power as output from the battery pack 1010. The battery pack 1010 can include any number of battery modules 1015. For example, the battery pack can have one, two, three, four, five, six, seven, eight, nine, ten, eleven, twelve or other number of battery modules 1015 disposed in the housing 1100. It should also be noted that each battery module 1015 may include a top submodule 1200 and a bottom submodule 1205, possibly with a cold plate 1110 in between the top submodule 1200 and the bottom submodule 1205. The battery pack 1010 can include or define a plurality of areas for positioning of the battery module 1015. The battery modules 1015 can be square, rectangular, circular, triangular, symmetrical, or asymmetrical. For example, battery modules 1015 may be different shapes, such that some battery modules 1015 are rectangular but other battery modules 1015 are square shaped, among other possibilities. The battery module 1015 can include or define a plurality of slots, holders, or containers for a plurality of battery cells 1020.

Battery cells 1020 have a variety of form factors, shapes, or sizes. For example, battery cells 1020 can have a cylindrical, rectangular, square, cubic, flat, pouch, elongated, or prismatic form factor. As depicted in FIG. 13, for example, the battery cell 1020 can be cylindrical. Battery cells 1020 can be assembled, for example, by inserting a winded or stacked electrode roll (e.g., a jelly roll) including electrolyte material into at least one battery cell housing 1300. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 1020 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can generate or provide electric power for the battery cell 1020. The housing 1300 can be of various shapes, including cylindrical or rectangular, for example. Electrical connections can be made between the electrolyte material and components of the battery cell 1020. For example, electrical connections to the electrodes with at least some of the electrolyte material can be formed at two points or areas of the battery cell 1020, for example to form a first polarity terminal 1305 (e.g., a positive or anode terminal) and a second polarity terminal 1310 (e.g., a negative or cathode terminal). The polarity terminals can be made from electrically conductive materials to carry electrical current from the battery cell 1020 to an electrical load, such as a component or system of the electric vehicle 1005. As indicated above, at least one of the electrodes of the battery cells 1020 can be manufactured by the systems (e.g., system 100) and processes (e.g., method 800) described herein.

For example, the battery cell 1020 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 1020 to separate the anode and cathode from each other and to facilitate transfer of lithium ions between the anode and cathode. It should be noted that battery cell 1020 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO3 (A=Li, Ca, Sr, La, and B=Al, Ti), garnet-type with formula A3B2(XO4)3 (A=Ca, Sr, Ba and X=Nb, Ta), lithium phosphorous oxy-nitride (LixPOyNz). In some embodiments, the solid electrolyte layer can include a glassy, ceramic and/or crystalline sulfide-based electrolyte (e.g., Li3PS4, Li7P3S11, Li2S—P2S5, Li2S—B2S3, SnS—P2S5, Li2S—SiS2, Li2S—P2S5, Li2S—GeS2, Li10GeP2S12) and/or sulfide-based lithium argyrodites with formula Li6PS5X (X=Cl, Br) like Li6PS5Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 1020 can be included in battery modules 1015 or battery packs 1010 to power components of the electric vehicle 1005. The battery cell housing 1300 can be disposed in the battery module 1015, the battery pack 1010, or a battery array installed in the electric vehicle 1005. The housing 1300 can be of any shape, such as cylindrical with a circular (e.g., as depicted), elliptical, or ovular base, among others. The shape of the housing 1300 can also be prismatic with a polygonal base, such as a triangle, a square, a rectangle, a pentagon, and a hexagon, among others such as pouch shaped. The housing 1300 can include other form factors, such as a triangle, a square, a rectangle, a pentagon, and a hexagon, among others. In some embodiments, the battery pack may not include modules. For example, the battery pack can have a cell-to-pack configuration wherein battery cells are arranged directly into a battery pack without assembly into a module.

The housing 1300 of the battery cell 1020 can include one or more materials with various electrical conductivity or thermal conductivity, or a combination thereof. The electrically conductive and thermally conductive material for the housing 1300 of the battery cell 1020 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 1300 of the battery cell 1020 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 1300 of the battery cell 1020 is prismatic or cylindrical, the housing 1300 can include a rigid or semi-rigid material such that the housing 1300 is rigid or semi-rigid (e.g., not easily deformed or manipulated into another shape or form factor). In examples where the housing 1300 includes a pouch form factor, the housing 1300 can include a flexible, malleable, or non-rigid material such that the housing 1300 can be bent, deformed, manipulated into another form factor or shape.

The battery cell 1020 can include at least one anode layer 1315, which can be disposed within the cavity 1320 defined by the housing 1300. The anode layer 1315 can include a first redox potential. The anode layer 1315 can receive electrical current into the battery cell 1020 and output electrons during the operation of the battery cell 1020 (e.g., charging or discharging of the battery cell 1020). The anode layer 1315 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 1020 can include at least one cathode layer 1325 (e.g., a composite cathode layer compound cathode layer, a compound cathode, a composite cathode, or a cathode). The cathode layer 1325 can include a second redox potential that can be different than the first redox potential of the anode layer 1315. The cathode layer 1325 can be disposed within the cavity 1320. The cathode layer 1325 can output electrical current out from the battery cell 1020 and can receive electrons during the discharging of the battery cell 1020. The cathode layer 1325 can also release lithium ions during the discharging of the battery cell 1020. Conversely, the cathode layer 1325 can receive electrical current into the battery cell 1020 and can output electrons during the charging of the battery cell 1020. The cathode layer 1325 can receive lithium ions during the charging of the battery cell 1020.

The battery cell 1020 can include an electrolyte layer 1230 disposed within the cavity 1320. The electrolyte layer 1230 can be arranged between the anode layer 1315 and the cathode layer 1325 to separate the anode layer 1315 and the cathode layer 1325. The electrolyte layer 1230 can transfer ions between the anode layer 1315 and the cathode layer 1325. The electrolyte layer 1230 can transfer cations from the anode layer 1315 to the cathode layer 1325 during the operation of the battery cell 1020. The electrolyte layer 1230 can transfer anions (e.g., lithium ions) from the cathode layer 1325 to the anode layer 1315 during the operation of the battery cell 1020.

The redox potential of layers (e.g., the first redox potential of the anode layer 1315 or the second redox potential of the cathode layer 1325) can vary based on a chemistry of the respective layer or a chemistry of the battery cell 1020. For example, lithium-ion batteries can include an LFP (lithium iron phosphate) chemistry, an NMC (Nickel Manganese Cobalt) chemistry, an NCA (Nickel Cobalt Aluminum) chemistry, or an LCO (lithium cobalt oxide) chemistry for a cathode layer (e.g., the cathode layer 1325). Lithium-ion batteries can include a graphite chemistry, a silicon-graphite chemistry, or a lithium metal chemistry for the anode layer (e.g., the anode layer 1315). For example, a cathode layer having an LFP chemistry can have a redox potential of 3.45V, while an anode layer having a graphite chemistry can have a 0.25V redox potential.

For example, lithium-ion batteries can include an olivine phosphate (LiMPO4, M=Fe and/or Co and/or Mn and/or Ni)) chemistry, LISICON or NASICON Phosphates (Li3M2(PO4)3 and LiMPO4Ox, M=Ti, V, Mn, Cr, and Zr), for example Lithium iron phosphate (LFP), Lithium iron manganese phosphate (LMFP), a layered oxides (LiMO2, M=Ni and/or Co and/or Mn and/or Fe and/or Al and/or Mg) examples NMC (Nickel Manganese Cobalt) chemistry, an NCA (Nickel Cobalt Aluminum) chemistry, or an LCO (lithium cobalt oxide) chemistry for a cathode layer, Lithium rich layer oxides (Li1+xM1-xO2) (Ni, and/or Mn, and/or Co), (OLO or LMR), spinel (LiMn2O4) and high voltage spinels (LiMn1.5Ni0.5O4), disordered rock salt, Fluorophosphates Li2FePO4F (M=Fe, Co, Ni) and Fluorosulfates LiMSO4F (M=Co, Ni, Mn) (e.g., the cathode layer 1325). Lithium-ion batteries can include a graphite chemistry, a silicon-graphite chemistry, or a lithium metal chemistry for the anode layer (e.g., the anode layer 1315). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 1325) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and Lithium iron manganese phosphate (“LMFP”). Anode layers (e.g., the anode layer 1315) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer), such as current collector material 194 can include a metal material. For example, current collector materials can include aluminum, copper, nickel, titanium, stainless steel, or carbonaceous materials. The current collector material 194 can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

The electrolyte layer 1230 can include or be made of a liquid electrolyte material. For example, the electrolyte layer 1230 can be or include at least one layer of polymeric material (e.g., polypropylene, polyethylene, or other material) that is wetted (e.g., is saturated with, is soaked with, receives) a liquid electrolyte substance. The liquid electrolyte material can include a lithium salt dissolved in a solvent. The lithium salt for the liquid electrolyte material for the electrolyte layer 1230 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 1230 can include or be made of a solid electrolyte material, such as a ceramic electrolyte material, polymer electrolyte material, or a glassy electrolyte material, or among others, or any combination thereof.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO3 (A=Li, Ca, Sr, La, and B=Al, Ti), garnet-type with formula A3B2(XO4)3 (A=Ca, Sr, Ba and X=Nb, Ta), lithium phosphorous oxy-nitride (LixPOyNz). In some embodiments, the solid electrolyte layer can include a glassy, ceramic and/or crystalline sulfide-based electrolyte (e.g., Li3PS4, Li7P3S11, Li2S—P2S5, Li2S—B2S3, SnS—P2S5, Li2S—SiS2, Li2S—P2S5, Li2S—GeS2, Li10GeP2S12) and/or sulfide-based lithium argyrodites with formula Li6PS5X (X=Cl, Br) like Li6PS5Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 1230 includes a liquid electrolyte material, the electrolyte layer 1230 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 1230 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 1230 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 1230 from greater than 0 M to about 1.5 M.

FIG. 14 depicts an example block diagram of an example computer system 1400. For example, the data processing system 101 of FIGS. 1 and 3-7 can include the computer system 1400. The computer system or computing device 1400 can include or be used to implement a data processing system or its components. The computing system 1400 includes at least one bus 1405 or other communication component for communicating information and at least one processor 1410 or processing circuit coupled to the bus 1405 for processing information. The computing system 1400 can also include one or more processors 1410 or processing circuits coupled to the bus for processing information. The computing system 1400 also includes at least one main memory 1415, such as a random access memory (RAM) or other dynamic storage device, coupled to the bus 1405 for storing information, and instructions to be executed by the processor 1410. The main memory 1415 can be used for storing information during execution of instructions by the processor 1410. The computing system 1400 may further include at least one read only memory (ROM) 1420 or other static storage device coupled to the bus 1405 for storing static information and instructions for the processor 1410. A storage device 1425, such as a solid state device, magnetic disk or optical disk, can be coupled to the bus 1405 to persistently store information and instructions.

The computing system 1400 may be coupled via the bus 1405 to a display 1435, such as a liquid crystal display, or active matrix display, for displaying information to a user such as a driver of the electric vehicle 1005 or other end user. An input device 1430, such as a keyboard or voice interface may be coupled to the bus 1405 for communicating information and commands to the processor 1410. The input device 1430 can include a touch screen display 1435. The input device 1430 can also include a cursor control, such as a mouse, a trackball, or cursor direction keys, for communicating direction information and command selections to the processor 1410 and for controlling cursor movement on the display 1435.

The processes, systems and methods described herein can be implemented by the computing system 1400 in response to the processor 1410 executing an arrangement of instructions contained in main memory 1415. Such instructions can be read into main memory 1415 from another computer-readable medium, such as the storage device 1425. Execution of the arrangement of instructions contained in main memory 1415 causes the computing system 1400 to perform the illustrative processes described herein. One or more processors in a multi-processing arrangement may also be employed to execute the instructions contained in main memory 1415. Hard-wired circuitry can be used in place of or in combination with software instructions together with the systems and methods described herein. Systems and methods described herein are not limited to any specific combination of hardware circuitry and software.

Although an example computing system has been described in FIG. 14, the subject matter including the operations described in this specification can be implemented in other types of digital electronic circuitry, or in computer software, firmware, or hardware, including the structures disclosed in this specification and their structural equivalents, or in combinations of one or more of them.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system to manufacture an electrode, comprising:
a first roller and a second roller that define a first tangent line, the first roller and the second roller configured to apply force to a battery active material received between the first roller and the second roller to form a film; and
the second roller and a third roller that define a second tangent line that intersects the first tangent line, the second roller and the third roller configured to apply force to the film received between the second roller and the third roller.

2. The system of claim 1, comprising:
the third roller and a fourth roller that define a third tangent line, the third roller and the fourth roller configured to apply force to a second film formed by the second roller and the third roller.

3. The system of claim 1, comprising:
the third roller and a fourth roller that define a third tangent line, the third the third roller and the fourth roller configured to laminate a current collector material and a second film formed by the second roller and the third roller.

4. The system of claim 1, comprising:
the first roller configured to rotate at a first angular velocity, the second roller configured to rotate at a second angular velocity, wherein the first angular velocity is different than the second angular velocity.

5. The system of claim 1, comprising:
the first roller comprising a first roller diameter, the second roller comprising a second roller diameter, wherein the first roller diameter and the second roller diameter are different.

6. The system of claim 1, comprising:
the first roller comprising a first roller diameter, the second roller comprising a second roller diameter, wherein the first roller diameter is smaller than the second roller diameter.

7. The system of claim 1, comprising:
an actuator coupled with the first roller to act on the first roller and exert a force on the battery active material at a first pressure point via the first roller.

8. The system of claim 1, comprising:
an actuator coupled with the first roller to act on the first roller and exert a force on the battery active material at a first pressure point via the first roller, wherein the second roller rotates about a fixed axis to transfer the battery active material from the first pressure point to a second pressure point.

9. The system of claim 1, comprising:
an infeed device configured to provide the battery active material to the first roller and the second roller, wherein the second roller and the third roller are configured to apply force to the film to form a second film, wherein the second film is thinner than the film.

10. The system of claim 1, comprising:
an infeed device configured to provide the battery active material to the first roller and the second roller, wherein the second roller and the third roller are configured to apply force to the film to form a second film; and
a web handling device to provide a current collector material to the third roller and a fourth roller, wherein the third roller and the fourth roller are configured to laminate the current collector material with the second film.

11. The system of claim 1, comprising:
the third roller and a fourth roller that define a third tangent line, the third roller and the fourth roller configured to laminate a second film formed by the second roller and the third roller;
a fifth roller and a sixth roller that define a fourth tangent line, the fifth roller and the sixth roller configured to apply force to a second battery active material to form a third film; and
the fourth roller and the sixth roller that define a fifth tangent line that intersects the fourth tangent line, the fourth roller and the sixth roller configured to apply force to the third film.

12. The system of claim 1, comprising:
the third roller and a fourth roller that define a third tangent line, the third roller and the fourth roller configured to laminate a second film formed by the second roller and the third roller;
a fifth roller and a sixth roller that define a fourth tangent line, the fifth roller and the sixth roller configured to apply force to a second battery active material to form a third film;
the fourth roller and the sixth roller that define a fifth tangent line that intersects the fourth tangent line, the fourth roller and the sixth roller configured to apply force to the third film;
a first actuator coupled with the first roller to act on the first roller and exert a force on the battery active material at a first pressure point via the first roller, wherein the second roller rotates about a first fixed axis to transfer the battery active material from the first pressure point to a second pressure point; and
a second actuator coupled with the fifth roller to act on the fifth roller and exert a force on the second battery active material at a fourth pressure point via the fifth roller, wherein the sixth roller is rotates about a second fixed axis to transfer the second battery active material from the fourth pressure point to a fifth pressure point.

13. The system of claim 1, comprising:
the third roller and a fourth roller that define a third tangent line, the third roller and the fourth roller configured to laminate a second film formed by the second roller and the third roller;
a fifth roller and a sixth roller that define a fourth tangent line, the fifth roller and the sixth roller configured to apply force to a second battery active material to form a third film; and
the fourth roller and the sixth roller that define a fifth tangent line that intersects the fourth tangent line, the fourth roller and the sixth roller configured to apply force to the third film to form a fourth film,
wherein the third roller and the fourth roller are further configured to laminate a current collector material with the second film and the fourth film.

14. The system of claim 1, comprising:
the third roller and a fourth roller that define a third tangent line, the third roller and the fourth roller configured to laminate a second film formed by the second roller and the third roller to form an electrode layer;
a fifth roller and a sixth roller that define a fourth tangent line, the fifth roller and the sixth roller configured to apply force to a second battery active material to form a third film;
the fourth roller and the sixth roller that define a fifth tangent line that intersects the third tangent line and the fourth tangent line, the fourth roller and the sixth roller configured to apply force to the third film; and
a seventh roller and an eighth roller that define a sixth tangent line, the seventh roller and the eighth roller to compress the electrode layer, the seventh roller and the eighth roller separated from the third roller and the fourth roller.

15. A method, comprising:
applying, via a first roller and a second roller, a first force to a first battery active material, the first roller and the second roller defining a first tangent line;
applying, via the second roller and a third roller, a second force to the first battery active material, the second roller and the third roller defining a second tangent line, the first tangent line intersects the second tangent line; and
laminating, via the third roller and a fourth roller, the first battery active material with a current collector material, the third roller and the fourth roller defining a third tangent line.

16. The method of claim 15, comprising:
applying, via a fifth roller and a sixth roller, a third force to a second battery active material, the fifth roller and the sixth roller defining a fourth tangent line;
applying, via the fourth roller and the sixth roller, a fourth force to the second battery active material, the fourth roller and the sixth roller defining a fifth tangent line; and
laminating, via the third roller and the fourth roller, the second battery active material to the current collector material.

17. The method of claim 15, comprising:
applying, via a fifth roller and a sixth roller, a third force to a second battery active material, the fifth roller and the sixth roller defining a fourth tangent line;
applying, via the fourth roller and the sixth roller, a fourth force to the second battery active material, the fourth roller and the sixth roller defining a fifth tangent line, the fourth tangent line intersects the fifth tangent line; and
laminating, via the third roller and the fourth roller, the second battery active material to the current collector material.

18. The method of claim 15, wherein the second tangent line intersects the third tangent line.

19. A battery electrode comprising a first battery active material laminated with a current collector material, the battery electrode produced by:
applying, via a first roller and a second roller, a first force to the first battery active material, the first roller and the second roller defining a first tangent line;
applying, via the second roller and a third roller, a second force to the first battery active material, the second roller and the third roller defining a second tangent line, the first tangent line non-parallel with the second tangent line; and
laminating, via a the third roller and a fourth roller, the first battery active material with the current collector material, the third roller and the fourth roller defining a third tangent line.

20. The battery electrode of claim 19, comprising:
the first battery active material laminated with a first side of the current collector material; and
a second battery active material laminated with a second side of the current collector material.
